(19) United States
(12) Patent Application Publication
(10) Pub. No.: US 2007/0187266 A1
(43) Pub. Date: Aug. 16, 2007

(54) METHOD, APPARATUS, AND SYSTEM FOR TRACKING UNIQUE ITEMS

(76) Inventors: Gilbert D. Porter, Cortlandt Manor, NY (US); Haresh C. Jotwani, Longwood, FL (US)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 11/674,768

(22) Filed: Feb. 14, 2007

Related U.S. Application Data
(60) Provisional application No. 60/773,718, filed on Feb. 15, 2006.
(60) Provisional application No. 60/747,955, filed on May 23, 2006.

(51) Int. Cl. B65D 71/00; B65D 85/00; B65D 69/00

(52) U.S. Cl. 206/232; 206/459.5

(57) ABSTRACT

A method, apparatus, and system for double-sided scanning, tracking, registering, identification storing and further handling by trading or collecting unique items. Specifically, the invention relates to a method, apparatus, and system for locating and tracking unique objects utilizing a computer controlled radio frequency system and radio frequency tags that are associated with unique objects in a manner that facilitates both protection, up-loading to a unique and secure web-based service site allowing secure registration of identified, verified ownership and authentication of the unique objects.

This application claims priority to U.S. Provisional Application Ser. No. 60/773,718; filed Feb. 15, 2006, and U.S. Provisional Application Ser. No. 60/747,955; filed May 23, 2006, both incorporated herein by reference.

### FIELD OF THE INVENTION

The present invention relates to a method, apparatus, and system for double-sided scanning, tracking, registering, identification storing and further handling by trading or collecting unique items. Specifically, the invention relates to a method, apparatus, and system for locating and tracking unique objects utilizing a computer controlled radio frequency system and radio frequency tags that are associated with unique objects in a manner that facilitates both protection, up-loading to a unique and secure web-based service site allowing secure registration of identified, verified ownership and authentication of the unique objects.

### BACKGROUND OF THE INVENTION

There is an enormous market for one-of-a-kind or limited production items, memorabilia, or collectables, herein referred to as unique items. This market is especially popular for trading cards. Trading cards are very popular collectable items for the sports and entertainment industries. Trading cards are often produced for baseball, hockey, basketball, football, soccer, golf, auto racing, comic characters, entertainers, and the like. A typical trading card has a photograph or image of a personality or character on a first side of the trading card, and related statistics, biographical information, or the like on the reverse side.

Due to their value, trading cards have become a significant “for profit” business. A large service industry has arisen around trading cards, offering services such as preserving and grading cards. However, unlike the Gem, Gold or Silver industry, there is no agreed standards institute to provide purchasers with an assayed value or description. Nor is there, as yet, even an agreed grading or rating system (like the CCCC of the Diamond trade). Therefore, several well-respected traders established their own grading standards (usually on the 1 to 10 scale) and applied them to the offered cards as a means of assuring the purchaser that a “mint” condition card was really of a quality that justified the value.

The grading process includes determining a trading card's overall condition. Criteria used in evaluating condition typically include image centering, card cut, corner conditions, edging, surface condition, such as scratches or stains, post-production trimming, creases or folds in the card, and the like. An owner would submit an item to the trader who, after evaluation, would charge a fee (e.g., $10 to $100) to “assay” the card.

To thereafter preserve the trading card's condition and to minimize the risk of subsequent tampering with the card, it is often put in a “slab,” thereby making it a trading commodity. “Slabbing” is a term used to describe the process of encapsulating a card after its condition has been determined. As shown in FIG. 1 (PRIOR ART), typically, a trading card 12 is sonically sealed in a hard acrylic case 10 and assigned a unique serial number and/or a bar code for registration purposes. Usually, these graded slabs carry the vendor ID number, the description of the item and the evaluated grade on a printed label 20. Protection is achieved by ensuring that any attempts to enter the slab destroy it, as it is comprised of two matched-halves that are sonically welded into a whole.

A number of companies offer grading (with varying levels of grading information included in a label unique to the grading company), authentication, and slabbing of cards. Some of the well-known companies include Beckett Grading Services (BGS offers a 10-point grading scale from 1 (Poor) to 10 (Pristine) and increments of one-half point such as 9.5 (Gem Mint)), Professional Sports Authenticator (PSA offers a 10-point grading scale from 1 (Poor to Fair) to 10 (Gem Mint)), Sportscard Guarantee (SGC uses a 15-point system that begins at 10 (Poor) and goes up to 100 (Pristine)), and Global Authentication, Inc. (GAI uses a 10-point grading scale and one-half point increments). A number of other graders also exist. Some graders also further authenticate with double-sided scans of the cards or item—all to ensure the customers know what they are buying and the graded value.

Tracking of the commodity and market pricing is in the basic stages, with catalogs and lists, and some online services. One of the best ways to get the value of a specific card or set is through online price guides. Another great online method for determining the value of a card is to look at completed auction data from the various auction sites such as eBay. On eBay's site, for example, when a potential purchaser sees a listing of an autographed item represented as having been authenticated by PSA/DNA, he can verify whether the item matches an item PSA/DNA actually authenticated by entering the item's unique certification (located on the item's PSA/DNA Certificate of Authenticity as well as the label affixed to the item). In most cases, though, this check only provides you with a summary description of the item, without information as to owner, location, or an actual scanned image.

However, for a collector or dealer with hundreds or thousands of cards in their collection, tracking and valuing cards can become overwhelming. Thus, it would be advantageous to have a method and system for tracking, registering, authenticating, and storing relevant and accurate data associated with each unique object to advance the assurance and value of these commodities, thereby enhancing both the owner's and trader's confidence and enjoyment.

### SUMMARY OF THE INVENTION

The present invention solves the above-stated problems in the art by providing a method, apparatus, and system for locating and tracking unique objects utilizing a computer controlled radio frequency system and radio frequency tags that are associated with unique objects in a manner that facilitates both protection and authentication of the unique objects. Although the present invention can be used to locate, identify and track any moveable object, it is particularly directed to collectable objects encased in containers, such as graded trading cards encased in slabs.

Features of the invention can be implemented in numerous ways, including as a method, apparatus, and system, a computer site (e.g., Internet/Intranet), and/or a computer readable medium. Parts of the invention preferably rely on a communications infrastructure, for example the Internet, wherein individual interaction is possible. Several embodiments of the invention are discussed below.

As an apparatus, features of the invention include uniquely modified containers for objects. Such containers are preferably sealed containers (e.g., slabs) having communication means in or on the container. In a particular embodiment, trading card slabs are sealed with cards and associated RFID tags sometimes over-printed printed with the suppliers trade mark (passive, active, or the like) to enable reading of unique identification or other associated and confirmed collated identification such as the bar-code of the grader related to the unique RFID identification information. Other embodiments include sensory responding means from the tag, including sound, light, vibration, or the like.

As a system, part of the invention generally includes a computing system having a database and a processor unit. The processor unit operates to receive information about the unique objects and to store the received information in the database. The computing system further includes associated devices (e.g., readers) to read the information from each of a plurality of unique objects. The output may include print or electronic media. Part or all of the data can also be sent electronically and maintained on a separate database or a web server for public and/or confidential access with typical browsers. The data may also be transmitted and viewed by other well-known techniques such as email, interactive television, and the like. The computer site is preferably viewed with a client web browser as an HTML document through a web secure server communicating with an application server having a database associated therewith. The program necessary for registered users to be able to utilize these features is downloaded from the website service on registration and a feature is embodied where each subsequent visit and log-on to the service is met with a search for any provided updates to the unique program.

As a computer readable medium containing program instructions for collecting and storing information from each of a plurality of unique objects, an embodiment of the invention includes computer readable code devices for receiving information about the unique objects and to storing the received information in the database. The computer readable code devices further include associated code input and output interfaces to read the information from each of a plurality of unique objects and output information as print or electronic media or send the output to a separate database or a web server for public and/or confidential access with typical browsers.

In an embodiment, the invention comprises a collection case comprising: a case having at least a first section and a second section, said first section for receiving a collectable object substantially visible through the case, and said second section for receiving printed identifying information regarding said collectable object substantially visible through the case; and a transponder tag disposed within the case allowing for remote retrieval by a transceiver of a signal from the transponder tag. The printed identifying information comprises grading information of the collectable object by a grading company. The transponder tag comprises an RFID tag. The RFID is one of passive, semi-passive, semi-active, or active RFID tags. The signal from the transponder contains data regarding said collectable object. The signal from the transponder contains data comprising a unique identification number. The collection case further comprises a sensory notification device to provide one of light, sound, or vibration. The sensory notification device responds to interrogation by a transceiver. The collection case may further comprise a display device for providing a visible user interface. The collection case may further comprise a second transponder tag located on the exterior of the case comprising second data regarding said collectable object and allowing for remote retrieval by a transceiver of a signal from the second transponder tag. For example, the collectable object is a trading card.

As a method, the invention includes a method of preserving and protecting a collectible object, comprising: receiving a collectable object and a corresponding grading report for that object, and encapsulating said collectable object, said corresponding grading report, and a transponder tag having a unique identification number in a substantially transparent case which allows for viewing of the collectable object and grading report and allows for remote retrieval by a transceiver of a signal from the transponder tag. In this method, the transponder tag may further comprise data regarding said collectable object. Further, the method comprises registering the collectable object by associating the unique identification number of the tag with information about the collectable object in an object record in a database. The transponder tag may further comprise data regarding said collectable object and said data is associated with information about the collectable object in the object record in the database. Additionally, the method may include associating image data of the collectable object with information about the collectable object in the object record in the database. Additionally, the method may include associating bar code data of the collectable object with information about the collectable object in the object record in the database. Additionally, the method may include associating one or more of grader identification, object data, owner identification, tag data, and image data with information about the collectable object in the object record in the database.

In another embodiment, the invention includes a method of grading, preserving, and registering a collectable object by a grader comprising: receiving a collectable object for grading; grading the object in accordance with a grading system; printing a label with information about the object including its grade; receiving a transponder tag, said tag including tag data; encasing the collectable object, label, and transponder tag in a case; inputting object information about the object including its grade and tag data as a record in a database, wherein the object information may be input during any stage of the process. Additionally, the method may include inputting image data of the collectable object into the record in the database and inputting bar code data of the collectable object into the record in the database.

The method of the present invention further comprises verifying the object in the database comprising reading the bar code and tag data from the object; and retrieving the record in the database that corresponds to the bar code and tag data and if no record is retrieved, flagging the record as “not verified”; otherwise, flagging the record as “verified.” Additionally, the method may include inputting image data of the collectable object into the record in the database if the record is flagged “verified.” The image data is preferably scanned by a dual-sided scanner that scans both sides of the object.

In another embodiment, the invention includes a method of verifying a unique collectable object comprising: receiving a signal from a transponder tag secured to a collectable object, said signal comprising a unique identification number; retrieving information from a database corresponding to that unique identification number; comparing the retrieved information with the unique collectable object to verify that the retrieved information matches the unique collectable object.

In another embodiment, the invention includes a method for identifying a discrepancy in an inventory of a collection of objects, each of the objects having a transponder tag affixed thereto, the method comprising: (a) transmitting a plurality of signals from a transceiver to a plurality of objects; (b) receiving a plurality of response signals comprising one response signal from each transponder tag affixed to each object; (c) generating a current inventory of objects from said plurality of response signals; (d) comparing the current inventory of objects to a previously stored inventory of objects; and (e) generating a list of objects in either the first inventory or the second inventory but not the second inventory or the first inventory to identify any discrepancies in the inventory caused by missing objects or additional objects.

The invention also comprises a dual-image scanner system comprising: two opposing scanning modules arranged to provide a double-sided scan of an object with a single operation; and a support for maintaining a gap between the two opposing scanning modules, wherein the gap is sized to fit three-dimensional objects. Additionally, the invention may include an object loader assembly disposed within the gap for receiving an object to be scanned. The object loader assembly may comprise a cassette guide for receiving a removable cassette that holds the three-dimensional object. Additionally, the invention may include a transceiver for reading a signal from a transponder located in the object. Additionally, the invention may include a bar code reader for reading a bar code on the object. The cassette guide receives one of a plurality of cassettes, and wherein each cassette sized for a particular three-dimensional object and the scanner settings are automatically configured for the cassette size.

The invention also includes an interactive online registry of data about collectable objects comprising: registry data comprising a plurality of data records for collectable items stored in a database, wherein each data record comprises transponder tag data obtained from each collectable object, said tag data associated with object data in each data record; and registry server providing a plurality of user access levels for registry data in the database. Preferably, each data record further comprises one or more of object data, owner data, tag data, image data, title, grade, grader, date, verification status, purchase date, current value, asking price, and sold price. The user access levels preferably comprise one or more of registrar access level, public user access level, grader access level, collector subscriber access level, basic subscriber access level, booth manager access level, booth user access level, and trade show promoter access level. The interactive online registry further includes communication devices to allow remote access to the registry server by a client component, said access limited by said access level. Communication devices are provided to allow registration of data about collectable objects by graders, wherein the data about collectable objects comprises transponder tag data obtained from each collectable object and object data. The basic subscriber access level allows access to the registry server for limited functions including one or more of browse collections, sort by owner, view sets, input and output of reports, and print. The collector subscriber access level allows access to the registry server for managing owner collections and verifying objects in conjunction with a transceiver. The portable booth manager access level allows access to the registry server for managing exhibition/show booth collections and verifying objects in conjunction with a transceiver. The grader access level allows access to the registry server for registering objects, scanning objects, and verifying objects in conjunction with a transceiver.

The advantages of the invention are numerous. First and foremost, the invention provides for a method by which graders can track, register, authenticate, and store relevant and accurate data associated with each unique object to advance the assurance and value of these commodities. The invention provides for a method by which dealers and consumers can use the above-noted information to assure the authenticity and value of their collection. Other aspects and advantages of the invention will become apparent from the following detailed description taken in conjunction with the accompanying drawings, illustrating by way of example the principles of the invention.

All patents, patent applications, provisional applications, and publications referred to or cited herein, or from which a claim for benefit of priority has been made, are incorporated herein by reference in their entirety to the extent they are not inconsistent with the explicit teachings of this specification. The following patents and published applications are incorporated by reference: U.S. Pat. Nos. 6,127,928, 6,282,819, 6,591,252, 6,735,324, 6,827,209, 6,839,453, 5,537,105, 5,550,547, and U.S. Patent Application Nos. 20020123955, 20040088231, 20040140349, 20040229696, 20040233040, 20050092823, 20050125405. The following additional patents and published applications are incorporated by reference: U.S. Pat. Nos. 4,949,189, 5,288,980, 5,431,389, 6,069,715, 6,760,491, 6,856,423, 6,873,715, and U.S. Patent Application Nos. US20050052713A1, US20050218225A1, US20050178832A1, and US20050139668A1.

### BRIEF DESCRIPTION OF THE DRAWINGS

The present invention may be more fully understood and appreciated by a description of conventional and certain embodiments in conjunction with the attached drawings in which:

FIG. 1 is a view of a conventional collection case known as a slab in the trading card industry.

FIG. 2 is a block diagram of a conventional RFID system.

FIG. 3 is a front view of collection case having an additional communication means in accordance with the present invention.

FIG. 4 is a front view of collection case having an additional visual communication means/indicator in accordance with the present invention.

FIG. 5A-B is a block diagram showing relationships of entities/subscribers.

FIG. 6 shows the Object Verification System and Interactive Registry.

FIG. 7 shows a block diagram of a dual-image RFID scanner system in accordance with the present invention.

FIG. 8A-8B illustrate a working embodiment of the components in the dual-image RFID scanner system in accordance with the present invention.

FIG. 9A-C illustrates a working embodiment of the exterior case for the dual-image RFID scanner system in accordance with the present invention.

FIG. 10 shows a preferred diagram of the loader assembly that supports the dual scanner RFID system and its loading cassette for receiving a slab to be scanned.

It should be understood that in certain situations for reasons of computational efficiency or ease of maintenance, the ordering of the blocks of the illustrated flow charts could be rearranged or moved inside or outside of the illustrated loops by one skilled in the art. While the present invention will be described with reference to the details of the embodiments of the invention shown in the drawing, these details are not intended to limit the scope of the invention.

### DETAILED DESCRIPTION OF THE INVENTION

Reference will now be made in detail to the embodiments consistent with the invention, examples of which are illustrated in the accompanying drawings. Wherever possible, the same reference numerals used throughout the drawings refer to the same or like parts.

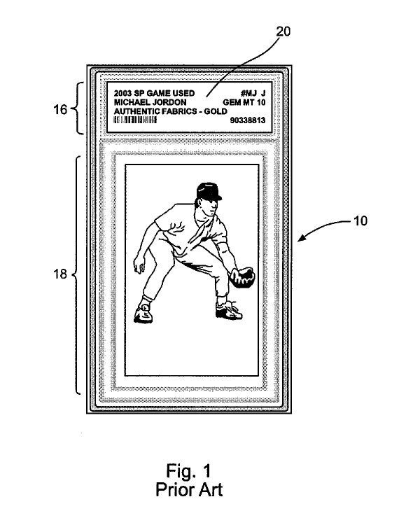

Conventional Slabs—Turning now to FIG. 1, a conventional collection case, known as a slab in the trading card industry, is shown. A trading card 12 is shown encapsulated in a case 10. Slabs can be displayed horizontally or vertically. In this example, the slab is oriented vertically. The internal cavity of the case is divided into an upper portion 16 and a lower portion 18. The trading card 12 is usually housed in the lower portion 18. The upper portion usually contains the grading label/report 20 and information from a specific grader (e.g., PSA, GAI, etc.). Preferably, an independent grading company grades the trading cards. The trading cards are preferably graded on a scale from 1 to 10 in half-point increments, where 10 is the highest score. A report for each graded trading card is produced by the grading company. The grading report contains such items as the card's overall grade, the card's subject matter, the card's publishing year, the publisher, the series number, a brief description, and an identification/serial number with associated bar code. The card is usually graded on image centering, card cut, corner condition, edges, surface condition, post-production trimming, creases or folds and the like. The identification/serial number with associated bar code is used for registration purposes as known in the art.

The case is preferably made from hard acrylic, Lucite, or the like and is substantially clear. Each face and edge of the encapsulated trading card can be viewed through the case. The case is sized or has internal stays to prevent the trading card from moving and may include a clear inner protection sleeve. The case is designed such that it can be stacked for storage. The case comprises of a front portion and a rear portion wherein the two portions lock together to encase and protect the trading card and grading label. Usually, the two matched-halves are sonically welded into a whole to prevent tampering.

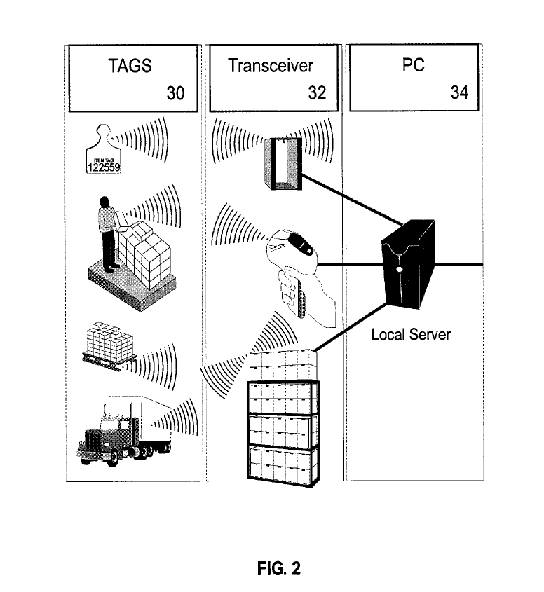

Conventional RFID Tags—Radio frequency (RF) identification systems utilizing RFID tags 30 are known in the art and are often used to determine the identification or location of certain objects (See FIG. 2). With such systems, either RF, light or sonic waves are illuminated onto tags attached to objects. After receiving the incident signal, the identified tag emits a response, from which the system determines the identification or location of the responding tag. RFID systems typically consist of one or more transceivers (exciters) 32 and one or more tags 30, with each tag attached to an object 10 whose identification or location is desired to be determined. RFID systems have been used for identifying vehicles, animals, parcels, laundry, people, railway cars, inventory in warehouses, golf balls, and the like. The systems generally communicate with a computing system such as a PC 34.

An RFID tag 30 is an electronic device that generally incorporates a specific and typically unique identification number (Electronic Product Code (EPC)), where the number may be “read” by an interrogating RF transceiver (transmitter/receiver) system. A “smart label” is an adhesive label with an RFID tag embedded inside. Smart labels contain 96 bits of information, including the product manufacturer, product name and a 40-bit serial number. The tag is generally attached to an object so that the object's presence or location in a given area may be identified by an interrogating RF transceiver system which “reads” the tag's identification number. Since the communication to the tagged object is by RF energy, such systems do not require direct line-of-sight between the transceiver and the tagged object and the tagged object may be located within a closed box, cabinet, or drawer.

RF tags, sometimes described as transponders, may be active (powered by a battery) or passive (acquiring energy from the incident radio frequency field). Passive tags, such as disclosed in U.S. Pat. Nos. 4,654,658 and 4,730,188, have fewer components, are smaller in size, and generally less expensive than active tags. In order to collect sufficient energy to operate, passive tags are located typically from one centimeter up to one meter from the transceiver.

RF tags typically consist of an antenna or a coil, to collect RF energy (from which the tag derives it's operating power), and an integrated circuit (IC) which contains an identification code or other information in its on-chip memory. Attaching a tag to an object enables the object to be located with the aid of an RF interrogation system. When the transceiver transmits a coded radio frequency signal, nearby tags collect energy from the transceiver's RF field. If the tag's ID number is the same as that encoded in the incident RF field, then the tag is activated by the incident RF field and, in response, modulates the incident RF field.

Commercially available passive RF tags generally operate at low frequencies, typically below 1 MHz. Low frequency tags usually employ a multi-turn coil. High frequency passive RF tags, operating around 2.45 GHz, and typically consisting of a single turn, flat antenna, printed onto a flat single layer sheet of plastic or paper are thin and thus, their thinness renders them suitable to use in the form of an adhesive label applied to an object.

Conventional RFID Readers and Systems—Several conventional RFID tag systems will now be described. RFID tag systems generally consist of a personal computer (PC) or other computing device, a radio frequency transmitter which sends an RF signal to the tag and which “excites” the tag into generating an RF response, and a receiver which receives the excited response from the tag.

A conventional RFID tag system architecture is illustrated in FIG. 2 and includes PC 34, transceiver (transmitter/receiver unit) 32, and passive tag 30. The communication link between PC and transceiver may be via hard wiring, RF, or optical link. Transceiver transmits an RF signal to tag, which excites tag. Transceiver then receives a response from tag, which is transmitted to PC for identifying the characteristics of tag. Examples of prior art RIFD systems employing this direct communication between the transceiver and the tag are disclosed in U.S. Pat. Nos. 5,537,105 and 5,550,547.

Other types of conventional RFID systems consist of a host transceiver, a plurality of local transceivers, and a plurality of tags a, b, c . . . n. In some instances, PC controls or exchanges data with host transceiver. Again, the communication link between PC and host transceiver may be via hard-wiring, via RF, or via an optical link. The plurality of local transceivers and the host transceiver generally each include a transmitter and a receiver, such as are known in the art. Each tag a, b, c, . . . n, which is attached to the object to be located, such as an animal, person, box, etc., contains a unique, preprogrammed identification number. A digitized RF signal in which the unique ID number is encoded is transmitted, at a first frequency f₁, from the host transceiver to the plurality of local transceivers. Local transceivers in turn transmit, at a second frequency f₂, the received RF signal to the plurality of tags a, b, c, . . . n. A particular tag (e.g., c) that is within the transmitted range and having the associated identification number will respond by modulating the second frequency f₂. The modulated RF field f₂ is detected by the receiver portion of local transceiver, thereby identifying the excited tag. The local transceiver then transmits, at a third frequency f₃, to host transceiver, which in turn identifies the tag data with the aid of PC. The identification and location of the excited tag can be determined because each local transceiver has a unique identification number, and PC and host transceiver can address each local transceiver uniquely and sequentially.

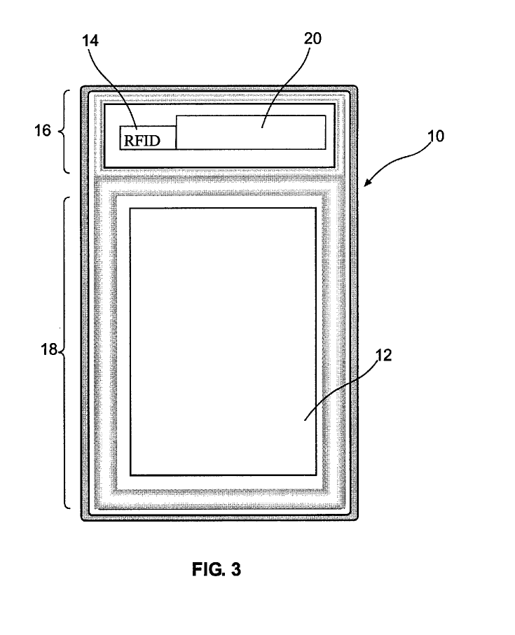

Tagged Slabs of the Invention—The present invention comprises a collection case having an additional communication means in accordance with the present invention. Turning now to FIG. 3, a collection case 10 of an embodiment of the present invention, in the form of a slab in the trading card industry, is shown. A trading card 12 is shown encapsulated in a case. The internal cavity of the case is preferably divided into an upper portion 16 and a lower portion 18, but other internal cavity arrangements are contemplated herein. The trading card is housed in the lower portion 18. The upper portion contains the grading label/report 20 and information from a specific grader including an identification/serial number. Moreover, the collection case contains an RFID tag 14 in accordance with the invention. Preferably, the RFID tag 14 is located in the upper portion adhered to the grading label 20. In certain embodiments, the RFID tag may be located elsewhere on or near the collection case or object. The two matched-halves of the collection case are sealed to prevent tampering as known in the art. A highly adhesive RFID tag is deployed that is usually distorted and thereby damaged and rendered unreadable in the event of tampering (‘breakaway’) as known in the art. Dual Grading RFID tagged labels can be mounted with Breakaway adhesive outside the slabs. They are for use when an existing slab is already graded by one company and the owner seeks additional grades. As each additional grade is granted the grader fixes a (Breakaway) labels over one portion.

Any of a number of suitable RFID tags may be used herein including passive and active, in accordance with the particular design. A passive tag is an RFID tag that does not contain a battery; the power is supplied by the reader. When radio waves from the reader are encountered by a passive RFID tag, the coiled antenna within the tag forms a magnetic field. The tag draws power from it, energizing the circuits in the tag. The tag then sends the information encoded in the tag's memory. Alternately, an active tag may be used. An active tag (including so-called “powered passive tags”) is equipped with a battery that can be used as a partial or complete source of power for the tag's circuitry and antenna. Some active tags contain replaceable batteries for years of use; others are sealed units.

The HF (High Frequency) family of transponder/tags is preferred as they can be small enough for application to the present invention and support anti-collision methods of reading and are cost effective; for example, HF transponders that meet the ISO/IEC 15693 standard (a standard for contactless integrated circuit cards (vicinity cards) operating at 13.56 MHz—such as the TI Tag-it HF-I Transponders). Suppliers of these tags include: Philips (I-Code SLI), Texas Instruments (Tag-It HF-I), Infineon (My-d SRF55VxxP), and ST Microelectronics (LRI512).

Preferably, when using passive tags, they will have the following configuration: Passive, standard ISO 15693, 13.56 MHz tags, Size: equal, or smaller than 2.2 mm×6.5 mm, labels, sticky on one side (with option of logo pre-printed on the other side); programmed with a unique number; and Read/Write capability.

Preferably, when using active tags, they will have the following configuration: Size target should be equal, or smaller than 2.2 mm×6.5 mm (with some degree of flexibility depending on power and features offered); ASIC solution preferred; Tags shall be similar to labels, adhesive on one side (with option of logo pre-printed on the other side) with alternative methods of securing considered; Read range should be at least 12″ to as remote as possible from associated Tags; Tag to be programmed with a unique number; Read/Write Tags; product range to include a solution that offers the ability to read other locally grouped tags (ideally Active and/or Passive) and relay the information back to the data collection point (PC or similar); Tag circuitry to include take-off terminals for additional features, power options including cell specifications and stated life, sound buzzer, LED or LCD or similar displays, preferred with memory chip.

In a first embodiment, referred to herein as a Basic Slab, an RFID tag is associated with the object. The tag can be provided as an adhesive label (smart label) for ease of use or can be provided as a pre-tagged grading label for use by the Grading House. Such tags are commercially available from a number of suppliers (e.g., Intermec, Paxar, Texas Instruments). For example, Texas Instruments' TI-RFid's line of 13.56 MHz vicinity cards incorporate a unique, factory-programmed ID, which cannot be duplicated or tampered with. Using the 2000 bits of memory, more than 30 times that of current proximity cards, the cards can be programmed on-site with additional information. The Licensees may utilize existing clamshell slab sizes and designs for this product. The Basic Slab could consist of specially manufactured versions of the Licensee's slabs to which a unique network RFID chipset based on the Texas Instrument ISO/IEC 15693 standard is applied by adhering a label in the area under the Licensee's Grading label at the top of the clamshell slab. Preferably, therefore the basic entry slab is wireless, data is permanently factory encoded and other associated data, supplied by the Licensee upon grading and slabbing, resides only on the Interactive Registry 200 to ensure security. It does NOT require to be ‘specially manufactured’ as the grader will insert an adhesive RFID tag between the proprietary slab labeling of the Licensee.

In a second embodiment, referred to herein as a Standard Slab, an RFID tag is associated with the object and the collection case further includes a sensory notification means to provide light, sound, or vibration upon receipt of certain commands. This slab could utilize wiring and magnetized contact points (on the bottom of the slab or on the front and back) permitting wired network contact to identify the presence of the RFID and a single LED at the top of the slab that will indicate (A) whether the slab has been placed in contact (directly or indirectly) with a network connection and (B) the identity of the slab in response to a request from the network for that specific item's ID. In the case of hard-wired contacting, the RFID reader will be based on a ‘shelf reader’ approach deploying an antenna array, multiplexed throughout the stock area. This would also be the preferred solution for Licensees Grading Centers, but RFID contact-less slabs with external power source for the LED could also be deployed. A Handheld reader could also be used by a collector to ‘find’ a specific item by reading many and lighting an LED on the selected item.

In a third embodiment, referred to herein as a Premium Slab, an RFID tag is associated with the object and the collection case further includes a sensory notification means to provide light, sound, or vibration upon receipt of certain commands. Furthermore, and LCD or other display device may be provided.

Should the smart label or RFID tag be affixed in a manner that can be accessed, known breakaway adhesive can be affixed the label, such that when an attempt is made to remove label from an object, the breakaway adhesive separates and leaves identifying data on the object as well as identifying information on the label. In this manner, when a label is placed on an object, an attempt to remove the label can be detected, such as by lack of adhesion areas on the removed label that uniquely identify the label, by the indications left on the original object, or in other suitable manner.

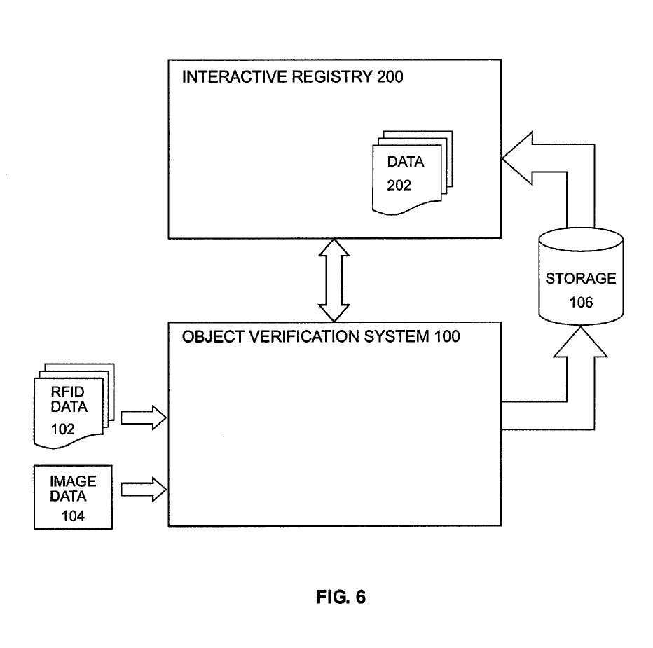

In operation, the tagged slab of the present invention increases the ability of an Object Verification System 100, Interactive Registry 200 (See FIG. 6), or other suitable systems to provide object verification and tracking by providing additional indications for determining the authenticity of an item.

Readers for Tagged Slabs—An RFID reader 32 is a device that is used to interrogate an RFID tag 30. The reader has an antenna that emits radio waves; the tag responds by sending back its data. RFID readers preferably make use of anti-collision algorithms to enable a single reader to read more than one tag in the reader's field. Any of a number of suitable readers may be used herein. Preferably, readers will support the ISO/IEC 15693 standard.

In a first embodiment, readers for the present invention have substantially the following configuration: read range to be equal to or less than 6″ (six inches) from associated tags, read capacity to be adjustable if possible from closest tag and up to 96 Tags or more on each read pass, powering to be AC/DC or Solar, reader to incorporate an Anti-Collision solution if multiple tag read capable. In this embodiment, multiplexed, long distance, remote readers for the present invention have substantially the following configuration: read range to be at least 12″ to as remote as possible from associated tags, read capacity to be equal or more than 96 Tags on each read pass, each read pass to be equal or less than 5 seconds (five Seconds) per 96 Tags or more read, powering to be AC/DC or Solar, reader to incorporate an Anti-Collision solution, reader to be capable of extending read range over larger areas by means of a sequencer, repeater or field exciters or other means—such multiplexing to be equal or up to 25 Antenna Array, feed—Ethernet is preferred but consideration given to coaxial, wireless, USB, Wan or alternative

In this embodiment, the antenna for the present invention have substantially the following configuration: Omni directional, Attenuated Range having a read range equal to or less than 6″ (six inches) from associated Tags and in a separate application equal or greater than 12″, read (proximity or radiated) capacity to be equal or more than 96 Tags or more each read pass, antenna to be flat, no more than 1″ (one inch) in thickness and of flexible, preferably clear material, antenna overall size to be from less than 12″ (twelve inches) square to 6′ square, but ideally be 21″×33″ or less.

In a second embodiment, readers for the present invention have substantially the following configuration: read range to be determined, with consideration for equal to or less than 6″ (six inches) and up to as remote from associated Tags as possible, read capacity to be from closest tag and up to 2,000 plus Tags or more on each read pass, read ability of both Active and Passive Tags will be preferred, powering to be AC/DC or Solar, reader to incorporate an Anti-Collision solution if multiple tag read capable.

In this embodiment, multiplexed, long distance, remote readers for the present invention have substantially the following configuration: read range to be at least 12″ to as remote as possible from associated Tags, read capacity to be equal or more than 96 Tags on each read pass, read ability of both Active and Passive Tags will be preferred, each Read Pass shall be equal or less than 5 seconds (five Seconds) per 96 Tags or more read. powering to be AC/DC or Solar, reader to incorporate and Anti-Collision solution, reader to be capable of extending read range over larger areas by means of a sequencer, repeater or field exciters—such multiplexing to be equal or up to 25 Antenna Array, feed—Ethernet is preferred but consideration given to coaxial, wireless, USB, Wan, WiFi or alternatives. A wireless relay for the present invention may be used and have substantially the following configuration: achieve a local read of many (ideally Active and/or Passive) tags then using a wireless relay technology to transmit such collected data back to the data entry point. Radio Frequency Identification (RFID) middleware is the software infrastructure that helps bridge RFID readers devices with the system using the information from the reader. This middleware is designed to interface with various reader devices and assist with the filtering, aggregation, and routing of RFID data from the reader devices to remote systems. In an embodiment of the invention, middleware will include device drivers for specific readers and an interface to higher-level software (such as a “SOAP” interface to a browser, an API or dotnet modules).

The invention may further include handheld (pocket PC) capability, having substantially the following configuration/functions (as better understood with reference to the Interactive Registry 200 described in more detail hereinafter): User Login, Browse Internet and Portal, subscribe and make payments view collection and sets, etc., Search for item at show, search for missing items from set, Assign items to show, Change ownership. Offline, Locate a specified tag, then beep and flash when in range, Inventory all tags scanned, Read a tag and display the information of the associated item, with owner option to view owner's notes such as purchase date and price paid, Add new item information and associate with the scanned tagID, Sync with server (registry and laptop data). Online functions: The handheld may: Run a web browser online, Be able to communicate with a host server via a wireless connection with a range of 60 feet and/or a USB cable with a range of 12 feet. Offline functions: The handheld may: Run windows mobile CE.NET (compatible with windows framework 2.0), Have a large clear display, Support an RFID HF reader card with CF or SD format.

The invention may further include RFID HF reader card capability, having substantially the following configuration/functions (as better understood with reference to the Interactive Registry 200 described in more detail hereinafter): RFID Reader Card will be either SD or CF format, RFID read range of more than 5 cm, Request modes: Inventory, Addressed, Non-addressed, Commands: Set, Read, (Write), Power Consumption—minimal, The battery to last at least 1 hour between recharge with a continuous read (Scan) operation in progress, A Power cord to be available.

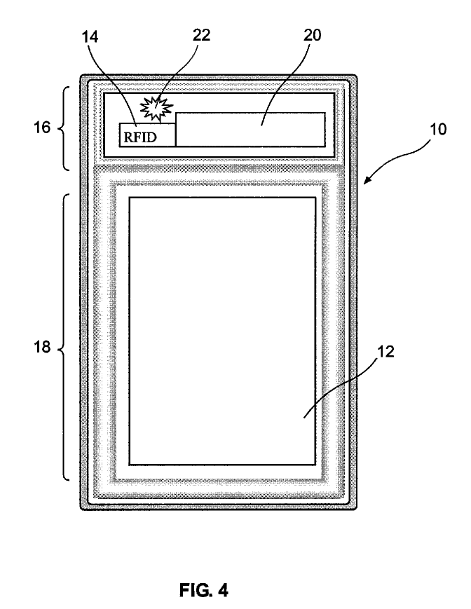

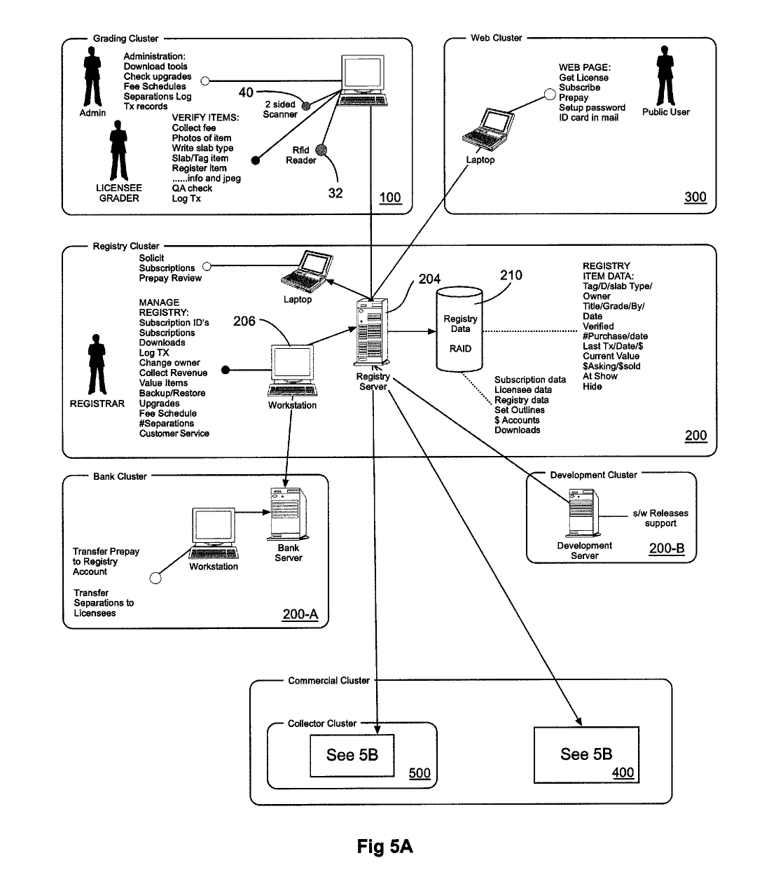

In an embodiment shown in FIG. 4, an indicator 22 is included and/or in association with the RFID Tag and/or slab. The indicator 22 can provide a signal (audio, visual, and the like) in response to certain functionality. For example, when the tagged slab 10 is interrogated (for example “FIND” command), the indicator 22 can indicate the tagged slab's location.

A signal from the RFID Tag chip is used to drive a buffer that enables the transducers. This signal is an AND function of the Power Supply on the chip and a function that is enabled once the RFID Tag chip is identified. An RC network is also provided to maintain the input signal condition for a short time after the signal is taken away and keeps the transducer turned on for a short specified amount of time.

There are several possible scenarios for implementation of this logic and circuit: (1) Separate applique along with the RFID Tag functions on the SLAB. (2) Integrate this with the RFID Tag chip. In the first scenario the chip already has a signal available on one of the unused pins. In the second case the chip has to be modified and redesigned for this new function.

One type of indicator 22 may include an LCD display strip that changes color when an RFID Tag is scanned. The LCD display strip can be small and lightweight and it takes very little current to change the color of the crystal display. Another option may be a tiny florescent gas tube approach. In this approach a tiny florescent gas tube is mounted on the RFID Tag. When a field is present in the immediate vicinity of the florescent gas tube the gases in the tube ionize and the tube glows. In the ambient state a ground is applied to the tube, which keeps the gases from ionizing. When the RFID Tag is addressed the ground is removed and the florescent gas tube floats and the gases can ionize in the presence of a field.

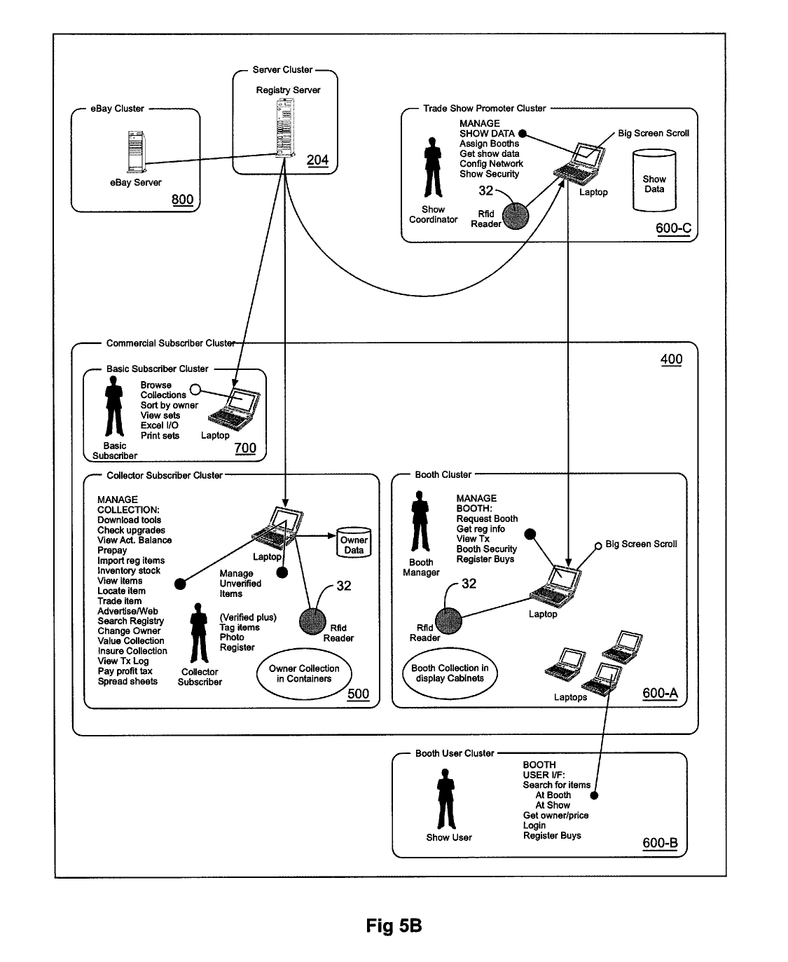

Object Verification System (OVS)—As known in the art, collectables are often authenticated and/or graded by third-party graders and then encased in a slab for security (See also Grading Cluster 100 of FIG. 5A). Most third-party graders then log the data regarding the graded objects into their own registry and include such data on a label associated with the object before slabbing and returning the object to the owner. Following this customary procedure, the present invention provides an improved verification system for graders and other parties associated with the collectables industry, referred to herein as the Object Verification System (OVS) 100. The Object Verification System 100 is used to populate the Interactive Registry 200, discussed in more detail hereafter.

Object Verification System 100 can be implemented in hardware, software, or a suitable combination of hardware and software, and which can be one or more software systems operating on a general purpose computer, server platform, or networked system, e.g., intranet or Internet. In one exemplary embodiment, Object Verification System 100 receives a plurality of data that is input by a scanner, a barcode reader, RFID reader, operator input, or other suitable processes. Data input to the Object Verification System 100 preferably includes the following for each object: (1) Grader ID, (2) Object data, (3) Owner ID, (4) Tag data, and, optionally, (5) Image data 104, each of which is discussed in more detail hereafter. Tag data 102 and image data 104 can be preferably captured simultaneously with the dual-image and RFID scanner system 40 of the present invention.

Grader ID preferably includes information to identify the grader and/or grading system used to grade/authenticate the object. This may be in the form of a serial number associated with the grader or other identification means. This information may be automatically generated (such as when only one Grader is accessing the system or logged on). The Grader's name/logo is generally printed on the label prior to slabbing.

Object Data includes, for example, object identification information (e.g., serial number and identifying bar code, description, and grade or qualification assigned thereto). Object data is generally printed on the label prior to slabbing.

Owner ID preferably includes information to identify the owner of the object. This may be in the form of a name/address and/or other number associated with the owner or other identification means.

Grader ID, Object Data, and/or Owner ID may already be logged or stored in a separate database of the grader, such as a relational database. If so, the stored data is accessed as known in the art and then transferred to the Object Verification System (automatically or manually). A label printer may be associated with the Grader's separate database to print custom labels according to the Grader's practice.

Tag Data 102 includes, for example, a unique object identification code (e.g., EPC), or manufacturer's ID, hereinafter Tag ID. The Tag ID in an embodiment is represented as 16 hex numbers. Tag data may further include Type ID for example identifying Slab type (Basic, Standard, Premium, or the like), in an embodiment represented as 2 ASCII characters. The tag itself is preferably applied to the inside-fold of label in such manner that the fold does not affect the RFID. Alternately, pre-tagged labels may be provided. The Object Registration System 100 receives data from the tag, which can be an RFID tag or other suitable authentication device that may be attached to an object, provided with an object, or otherwise included with object, by means of a tag reader.

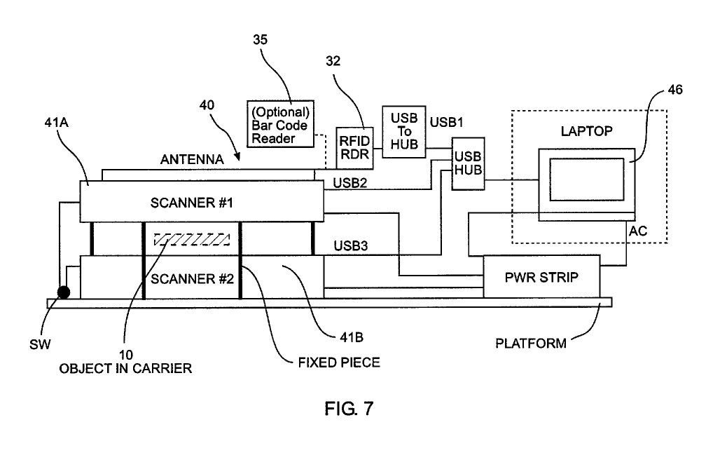

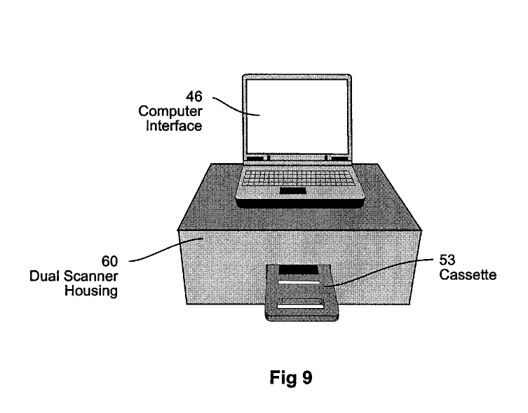

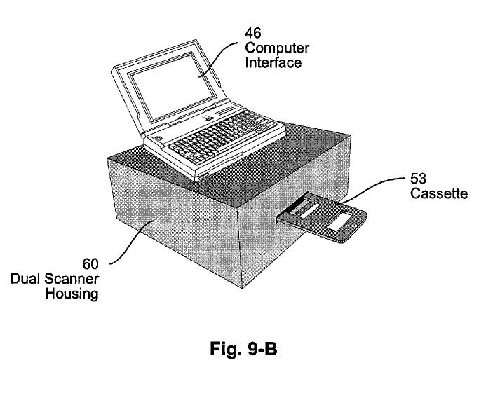

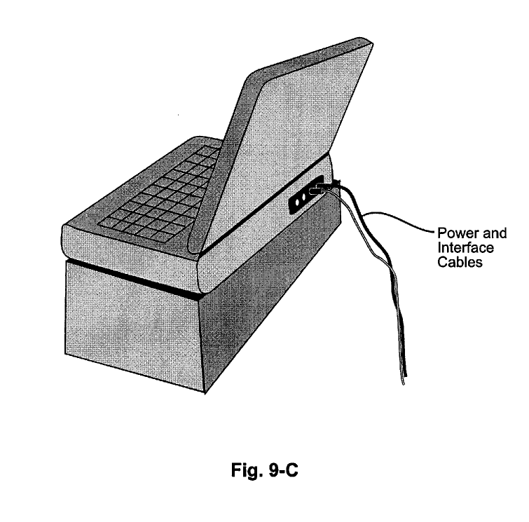

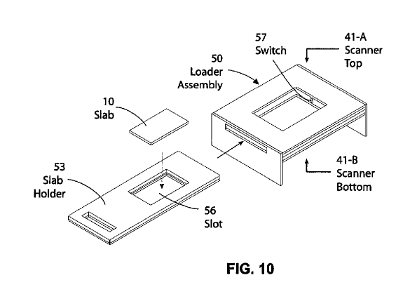

Image Data 104 is preferably obtained by optically scanning the object, front and back, at a resolution suitable for identification. Tag data 102 and image data 104 can be preferably captured simultaneously with the dual-image and RFID scanner system 40 of the present invention, described in more detail below and illustrated in FIGS. 7-10. The present dual-image scanner 41 will be described herein with reference to an image capture device, such as a scanner that generates a digital image for storage, transmission and/or further processing. The teachings of the present invention may be used with respect to other types of image capture devices, such as photocopiers, facsimile machines, printers, and/or the like. Other suitable means for obtaining image data, as known in the art, may be used, such as digital photography, digital photocopying, or the like. According to one aspect of the present invention, a dual-side scanner 41 includes a first scanner 41a that can scan a first side of an object, to provide a first side image data 104, and a second scanner 41b, connected to the first scanner, that can scan a second side of the object to provide a second side image data 104. Each scanner includes data transfer device that transfers the first side data to an external device/computer 46 and the second side data to the external device/computer 46. RFID data 102 is also acquired and transferred to an external device/computer 46. The collective data stored in the memory of the external device/computer can then be associated (first side associated with second side associated with RFID data) and transferred to a database in accordance with the other aspects of the invention.

Object Verification System/Grading Cluster 100 collects and associates the above-noted plurality of data and stores this data 202 and/or transmits the data for remote storage or use by other systems, such as Registry System/Registry Cluster 200. Preferably, the grader uses the Object Verification System 100 as part of his customary grading system for newly received objects as follows (it should be understood that in certain situations for reasons of efficiency, preference, ease of maintenance, or to integrate with existing systems, the ordering of the Steps shown below could be rearranged, combined, or separated, by one skilled in the art): Step 1. Third-party grader receives object for grading/authentication, etc. and logs the object into its database for tracking purpose. Step 2. The Grader then grades object in accordance with such third-party grading system as known in the art thereby compiling and adding Object Data to its database. Step 3. After grade is determined and prior to actual slabbing of the object, a customized label is printed by the Grading House (usually indicating card identification information with serial number and identifying bar code). Step 4. Grading House then adds RFID tag 14 to inside-fold of label 20 in such manner that the fold does not affect the RFID. Alternately, the label is pre-tagged (e.g., the RFID is pre-installed on each label at point of manufacture or is custom printed onto the label by specialty printer so that this step is not necessary). Step 5. Object (such as a trading card) 12 with label 20 is placed in slab 10 and slab is sonically welded closed and any final database updates and quality control measures may be undertaken, if necessary. Step 6. As a final step before return shipping the object to the owner, data is input into the Object Verification System 100 and “verified,” wherein verification may include the extra step of obtaining image data 104 of the object (if image data is was not already obtained).

In an embodiment, Step 6 is accomplished as follows: (a) The object is placed on a customized double-sided scanner 41 containing a bar code reader 35 (or the OCR recognition is obtained by fixed reading areas positioned to read the Grading House bar code identification from the scanned image) and an RFID reader 32 (positioned to read the RFID tag). (b) The Object Verification System 100 identifies the object (and the corresponding database record for that object) by reading the bar code of the item and synchronizes that information with the RFID identification information. Preferably, a display (e.g., connected computer monitor) will provide an ongoing view of scans and linked database information to the Grading House, if desired, as ongoing quality check. (c) If the dual-read and file synchronization is successful, a successful indication will be provided (e.g., a green display LCD will light or a customized error message will be displayed on the PC screen) and the object will be placed in a reading-slide and slid into the scanning area (or in another version auto-fed) into the image scanner (See FIGS. 7-10) to obtain an image file (preferably, the image file's front and back scans are automatically named as the “F” and “B” variation files using the bar code ID as the primary file name). If for any reason synchronization is not successful (i.e., failed read of bar code or RFID or failed file access to database), an unsuccessful indication is provided (e.g., a red LED will light) and scanner will not activate (with relevant failure information displayed on any connected display). (d) On completion of a successful scan, the Grading House database files are completed (optionally with image data automatically added to the Grading House file) and all of the data including the TAG data is collected by the Object Verification System 100 and properly associated with the above-noted plurality of data. Preferably, Grading House retains no information as to TAG data since that data is designed to be used by the Interactive Registry 200. (e) The Object Verification System 100 stores this data and/or transmits the data for remote storage or use by other systems, such as Interactive Registry 200 (and used to populate the Registry Database). Objects having data input in accordance with the requirements of the Object Verification System 100 are referred to as VERIFIED. Preferably, the OVS data files for all objects are automatically sent the Interactive Registry 200 (constantly, periodically, batched, or otherwise).

Alternately, Step 6 may be accomplished by individual/separate scanning of bar code (to access Grading House database information associated with the bar code), RFID, and image, then linking this information into an OVS data file. In cases where the image data was already obtained and part of the Grading House database, then the step of image scanning would not be necessary. In order to confirm that the data in the OVS data file is properly associated (correct owner, object data, tag ID, etc.), a confirmation step may be performed. In this confirmation step, a reader reads the Object Data (e.g., bar code reader) and Tag ID (e.g., RFID reader) and then compares that data to what is currently stored in the OVS data file. If the records match, a signal is generated to indicate that the object is correctly accounted for in the Object Verification System 100. If the records do not match, then another signal is generated (e.g., an error signal). An error signal may result if the database is corrupted, data is missing, or data is not properly associated (the Object Data does not match the Tag ID). The confirmation step may be executed at any time and can be used as a final verification step prior to the object leaving the possession of the grader.

In a preferred embodiment, the data files from each Grading House will include, at minimum, (1) hi-resolution image scans (e.g., 400 dpi minimum) of front and back of each object, (2) full Object Data (e.g., label information, including Grading House serial/bar code numbers, grade and description of item), (3) Owner ID (e.g., customer name, customer's account number at Grading House, mail, phone and email contact information for customer).

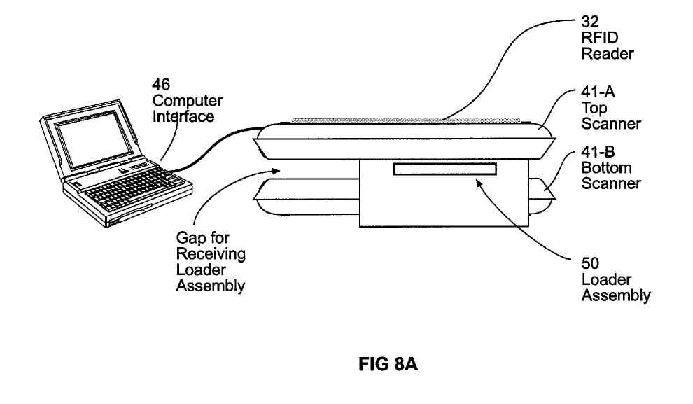

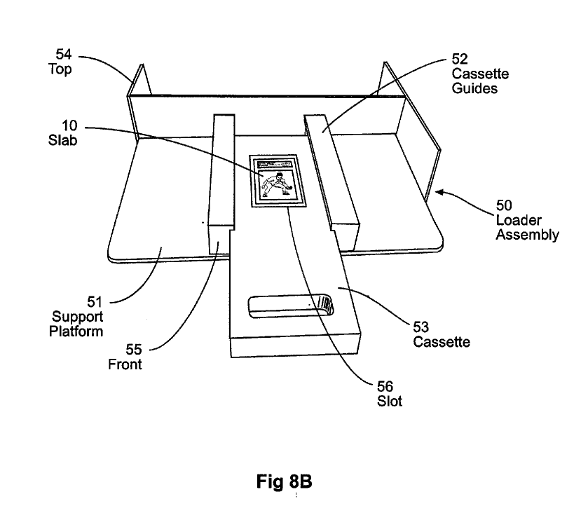

Turning now to FIGS. 7-10, a preferred embodiment of the dual-image and RFID scanner system 40 will now be described. FIG. 7 shows a block diagram having two opposing scanners 41a and 41b (or scanning modules) arranged to provide a simultaneous (substantially the same or approximately the same time) double-sided scan of an object with a single operation. As shown in the example prototype in FIG. 8A, the two scanners 41a and 41b are arranged with one at the bottom and the other at the top leaving a gap therebetween for scanning 3D objects. The bottom scanner 41b scans the bottom of the object and the top scanner 41a scans the top of the object when the object is inserted between the two scanners. Accordingly, with a single operation both the top and bottom images of an object are obtained. If only one side needs to be scanned, the scanner may be modified to scan only one side.

The top and bottom scanner 41a and 41b are preferably aligned parallel with each other with enough separation to allow insertion of the 3D object, such as a tagged slab 10. In an alternative embodiment, if desired, instead of being aligned with each other, the scanners may be offset from each other to reduce the effect of “bleed-through” of light. Alternately, the scanners may be offset 180° such that the top scanner will begin scanning from one end of the object and the bottom scanner will begin scanning from the other end. The scanners may operate simultaneously or sequentially.

As known in the art, a typical scanner/scanning module preferably comprises a photosensitive device. Photosensitive device preferably includes at least one generally linearly-arranged sensor or chip having a plurality of individual sensor elements or pixels. Photosensitive device preferably comprises Contact Image Sensor (CIS) optical sensors. Embodiments of the present invention contemplate the use of any suitable image sensors now known or developed in the future such as, but not limited to, charge-coupled device (CCD) optical sensors, complementary metal-oxide semiconductor (CMOS) optical sensors and others. The scanner/scanning module also preferably comprises a light source. The type of light source used may be based on a desired scanning speed. Light source preferably comprises a light-emitting diode (LED). In another embodiment, light source may comprise a cold cathode fluorescent light (CCFL). Embodiments of the present invention contemplate the use of other light sources now known or developed in the future. A lens, for example a gradient index lens array, is preferably disposed between photosensitive device and platen such that a longitudinal axis of lens intersects photosensitive device.

In order to facilitate scanning of a 3D object (such as a card, slab, coin, stamp, comic book, or other item for which single-sided or dual-sided scanning is desired), an Object Loader Assembly 50 is provided (FIG. 8b). The Object Loader Assembly 50 preferably comprises a support platform 51 having a horizontal cassette guide 52 for receiving a removable cassette 53 that holds the 3D object. The support platform 51 is positioned between the two scanners 41a and 41b. The Object Loader Assembly 50 may take on various designs depending on the 3D object to be scanned, utilizing different feed mechanisms as known in the art (e.g., with or without utilizing the preferred horizontal cassette guide/slide and removable cassette embodiment).

For example, the feed mechanism may comprise the horizontal cassette guide/slide 52 for receiving a removable cassette 53 containing the coin, stamp, comic book, etc. Alternately, another form of feed mechanism may be used. For example, a belt drive or other automated mechanism may be utilized to move the 3D object across the scanning surface. Moreover, a type of automated feed may be utilized similar to 35 mm slide mechanisms and stack loaders. For irregularly sized objects wherein the spacing of the scanners may need to be changed, gas struts or similar mechanisms may be utilized. The mechanisms would hinge and/or support the upper and lower scanner modules to facilitate scanning of such irregular sized objects. Other features of the invention, such as RFID and bar code scanning, can be accomplished for these other items in the same manner as described with respect to the preferred embodiment.

In the preferred embodiment, the support platform 51 of the Object Loader Assembly 50 is preferably constructed of black Plexiglas or other suitable material (preferably non-glare) and sized to fit between the top and bottom scanners 41a and 41b and to support the cassette 53 that holds the 3D object (e.g., slab) 10. The platform 51 is generally configured in the shape of a rectangular box having a top 54, bottom, front 55, back, and two sides. The top 54 of the support platform receives and supports the top scanner 41a (scanner situated face down so that the scanning surface faces the cassette) and has a center opening to expose the scanning surface of the top scanner 41a. The bottom of the support platform fits above the bottom scanner 41b (scanner situated face up so that the scanning surface faces the cassette) and has a center opening to expose the scanning surface of the bottom scanner 41b. The front 55 of the support platform 51 has an opening for insertion of the cassette 53. The support platform 51 may further include cassette guides 52 to receive and position the cassette 53 centered between the two scanners 41a and 41b. A switch 57 is preferably located inside along the back of the support platform 51, positioned such that the cassette 53 contacts the switch when fully inserted. The switch may be used to automatically actuate the scanners and/or the RFID reader and/or software associated therewith.

An object, such as a Slab, is placed into an appropriately sized slot in the cassette. Preferably, a plurality of cassettes may be provided, each having a slot sized to receive the most common Slab sizes. For example, one cassette is sized to receive the regular GAI slabs, one cassette is sized for the regular SGC slabs and one cassette is sized for the All Star slabs. The Slab is securely held in the cassette. Once the cassette is fully inserted into the cassette guide, by sliding it horizontally along the cassette guides until it reaches the back of the support platform, it contacts a switch that actuates the scanners and/or the RFID reader and/or software associated therewith. In a preferred embodiment, a contact mechanism, such as a push button, is located to the back of the cassette guide such that the cassette comes in contact with the push button when fully inserted. Alternately, a manual start control button or GUI control button may be provided to actuate the scanners and/or the RFID reader.

Once activated, and after any preliminary steps associated with RFID and/or bar code reading and confirmation, the scanners then respectively scan images of the top and bottom of the object within the cassette. The two sides of the object may be simultaneously or sequentially scanned. In a preferred embodiment, the scanning is simultaneous. In this manner the scanners are operating in duplex mode during which the top scanner is used to scan the top side of object and the bottom scanner is used to scan the bottom side of object to generate digital images of the two sides. Each of the scanners is operable to capture data such as, but not limited to, text, graphics, illustrations, and images, from the side of the object facing the particular scanner.

If the loader assembly is not utilized, the two scanners could be hinged or otherwise moveably connected to allow insertion of the objects therebetween, Moreover, for example, on the scanner surface, scanner cover guide markings may be provided that comprise graduated markings on the scanner. The object is placed on the scanner surface in the upper right corner. If the object fits within the first guide marking, it would be a size#1 object, if the object is larger but fits within the second guide marking, it would be a size#2 object, if the object is still larger but fits within the third guide marking, it would be a size#3 object, and so on. Each object size could then have an appropriate scanner setting or button to allow the scanner to capture the object image size appropriately. Multiple buttons on the scanner could be provided and chosen based on the guide or automatically set. Also, a pre-scan by the scanner could detect the object size and then automatically adjust the image size based on the pre-scanned object size, as known in the art.

Once scanning is complete, the digital images of each side of the object may be transferred and processed. For example, one or more of the digital images may be printed or displayed. If desired, the printing or displaying of the digital images may occur simultaneously with the scanning of the object. The image data is then transmitted and stored. In a preferred embodiment, the image data is placed in a database on a separate computing means, having an appropriately named directory, for example, a subdirectory called “Scan” under the folders “Top” and “Bottom”. In an exemplary embodiment, each scanner has a data interface (e.g., USB cable) to connect to a computing means (e.g., Laptop PC). Each scanner and the computing means are powered (e.g., battery or connected to an AC power supply).

As a method of dual-scanning, the invention comprises the following steps: First the 3D object is placed in the slot of the cassette and the cassette is inserted into the support platform. The scanners are then activated (automatically or manually). In the scanning step, image data from both the first and second sides of the object is captured. An optional OCR step may be performed to convert the scanned image data into text data. The image data is transmitted and/or saved. In an association step, the first side image or text data is associated with the second side image or text data, and in a storage step the associated data is stored in memory, on a hard disk, on a CDROM, or on other recordable media. The method then reaches an end step.

In order to also provide for RFID scanning, an RFID Reader may be located in the readable range of the cassette, such as placed on top of one of the scanners. If the object or Slab has within it an RFID Tag, the RFID Reader reads this Tag as the cassette is loaded into the Object Loader Assembly. This Tag ID data is then transmitted and stored. In a preferred embodiment, the Tag ID data is placed in a database, having an appropriately named directory, such as another subdirectory labeled for RFID Tag ID data. The RFID Tag ID data is associated with the corresponding image data for the object. The RFID read step may be undertaken prior to the image scan step and used as a precursor to activating the scanners (such as object confirmation, etc.).

An optional bar code reader 35 may also be utilized should the 3D object also have a bar code that is desired to be read, stored, and associated with the image and/or RFID data or as a confirmation step. The bar code reader 35 may be part of the scanner and OCR solution or a separate device located such that the bar code can be easily read when the 3D object is in the cassette or at any time during the process.

Embodiments of the present dual-image scanner may be implemented in software, hardware, or a combination of both software and hardware. The software and/or hardware may reside on an image capture device (scanner or multi-function machine) or on a computer system associated with an image capture device. If desired, part of the software and/or hardware may reside on an image capture device and part of the software and/or hardware may reside on the computer system. If desired, the different functions discussed herein may be performed in any order and/or concurrently with each other. Furthermore, if desired, one or more of the above-described functions may be optional or may be combined without departing from the scope of the present invention.

The dual-image and RFID scanner system 40 may comprise custom designed hardware/software to accomplish the objects of the invention or existing commercially available hardware/software may be utilized. In the examples described herein, HP brand scanners and software are described. However, the dual-image and RFID scanner system may employ scanner modules and software available from other manufacturing sources. The dual-image and RFID scanner system is preferably collectively enclosed in a suitable housing 60. Power and interface cables/connectors (e.g., USB, USB hubs, serial, parallel, firewire) exit the housing for connection to external power source(s), if necessary, and to a computing means 46 (e.g., laptop PC). Alternately, the computing means may also be located in the housing, with only input/output devices (e.g., keyboard, mouse, display) external thereto. Certain devices may be battery powered. Software interface between the scanners/RFID reader and the computing means may comprise accessing control features from software supplied with the hardware devices or other commercially available software or custom software written for the specific purposes of the invention.

Operation of the dual-image and RFID scanner system will now be described using HP brand scanner hardware/software merely as an example embodiment. Initially, the hardware devices will be powered up (e.g., scanner, RFID reader). Upon power up, the two scanners 41a and 41b within the housing 60 will generally initialize i.e., the scan heads will momentarily move up and come back to initial position, the scanner lights inside the scan head will turn on. The RFID reader 32 will also turn on. The computing means 46 is also turned on to establish an interface with the dual-image and RFID scanner system 40.

When using off-the-shelf scanners, scanner configuration can be accomplished using the scanner software provided therewith. For example, if using HP brand scanners, the “HP Solution Center” software interface is used to configure the scanners. Preferably the scanning resolution would be adjusted to a preferred setting (typically between 200 dpi and 800 dpi) and the level of compression would be adjusted as appropriate for file storage and image quality as a matter of design choice.

The preferred scanner settings for scanning Slabs are as follows: Preferably to avoid unnecessary image data, the cropping option for the scanner is set to “automatic”. The profile can be set to the outline image of the object as shown in the “preview” as the scan is progressing. All views can be disabled to save time, such as the preview or setting options to provide the minimum time for scanning. The RFID interface software is loaded. In an embodiment, the SOAP software will load automatically for the RFID reader. There are several versions of readers and the SOAP software looks for the right version provided in the system. The dual-image and RFID scanner system control software, referred to herein as the Scan-client, may be used to control the dual-image and RFID scanner system to acquire and associate data in accordance with the invention. The Scan-client may be a stand-alone system provided locally or in cooperation with a server residing on a network, including the Internet.

In a preferred embodiment, the Scan-client software runs on a local computer (Laptop PC) and displays two windows on the screen, one is an FTP window referred to as the “Registration Client” for transmission of information to an exchange server. The FTP window shows files ready to be transferred to the exchange server, files transferred and the average size of the files. This window is for monitoring the flow of information to the server. The other window is the “Grade Station Control Station” window, which is the main interface for the user to obtain the RFID data and two sided Slab images.

When used with the three standard cassettes (each one sized to fit one of regular GAI slabs, regular SGC slabs, or All Star slabs), the cropping for these three slabs is very close and, except for the border, the entire image is completely visible when scanning with any of these three cassettes. Scanning profiles may be provided for the above-mentioned slabs. Additional scanning profiles may be provided based on the dimensions of slabs from other Graders. In a preferred configuration, both the scanners have been set to provide desired resolution, compression, and cropping. The cropping, the dpi and the compression can be changed for the scanners to other values, as known in the art.

Different scanner settings may be desired for different types, sizes, and categories of 3D objects. The appropriate scanner setting may be manually set prior to the scan. Or, more preferred, a method for automatically setting the scanners and/or RFID reader may be provided. In such an embodiment, the type, size, or category of the 3D object to be scanned may be recognized by the system and automatically load the desired settings. Recognition could be provided by a form of optical or mechanical shape recognition of the 3D object or its cassette, or by an embedded RFID, bar code, or other form of identification. With such automatic recognition, the scanner settings such as image size, etc., can be automatically loaded.

Alternately, a series of selections may be provided to the user (hardware buttons or software selections/buttons), each selection corresponding to a different set of scanner settings optimized for a particular 3D object. In that way, the user can select a single selection that will make the appropriate changes to a number of settings, rather than having the user change each setting individually.

The software interface from a user's point of view in a particular embodiment will now be described. If desired, the different functions/steps discussed herein may be performed in any order and/or concurrently with each other. Furthermore, if desired, one or more of the above-described functions may be optional or may be combined without departing from the scope of the present invention. The particular GUI described herein may be modified as a matter of design choice. Using a different brand of scanner or scan software will result in different profiles, settings, and steps. While scanners and scanning software differ from model to model, the following steps show the basics of scanning an item into a computer (other scanning software may have options that are automatic). Scanning software interface elements and menus may differ, but the types of selections will generally be the same. The following example uses HP brand scanners.

To begin the data acquisition process, the “Grade Station Control Station” and the FTP windows are displayed on the screen; automatically appearing once the software is loaded. A user clicks on a “Start RFID” tab on the “Grade Station Control Station” window. Several events will then occur: the “Start Soap,” “Is connected,” and “Read Tag Off” buttons become green and the RFID reader reads the Tag on the antenna and a blue box will turn to light orange and the text will record “Found 1 transponder(s)” etc., below it “1 Tag found” is displayed. The green timing bars will repeat every 15-20 seconds which is a periodic scan cycle for software to read the RFID Tags. If more than one tag is found, the additional tags should be located and removed from the read area. The “one tag found” is used to identify the scan station and the scanner preferably will not operate until only a single tag has been read.

There are three picture buttons on this window: “Start Reader” which gives the information of the RFID reader type, Comm. Port, etc. (Note: the “Start Scan” button is only “reserved” from previous releases and can be ignored). The “Registration” button shows the Image scan—sometimes it shows the Top image and sometimes the Bottom image. The transfer of images may appear so fast that only the last image shows in this box.

A 3D object (e.g., Slab) 10 is loaded in the cassette 53 and it is then inserted into the slot of the Object Loader Assembly 50 and pushed all the way until it makes contact with an end stop and/or switch. In approximately 15-20 seconds, the RFID tag 14 is recognized by the RFID reader 32 and the light orange color of the window becomes blue and green and the text will read “Found 2 transponder(s) etc. and the below it “2 Tags Found” is displayed.

Next, the image scanning process is begun. If not started automatically upon insertion of the cassette, a manual scan-start button may be used, such as pressing a push-button on the outside of the housing. A scanning logo appears on the screen three times and then disappears followed by two scanning windows, which indicate, “preparing to scan”. Once the green timing bars in this window are full this window will disappear and a new scan can be initiated by repeating this process. If the new scan is initiated too soon before the previous scan has a chance to be completed the scan system will produce an error message “The application is currently in use or unavailable. Close any open program and try again.” Click OK and resume. On the FTP window, the file ready value increases as the Slabs are scanned and as they are sent to the server. This number reduces and the transferred number increases based on the files transferred.

Going to the scanner “Solution Center” can optionally alter the scanner settings. The Settings button points to the “Scan settings and Preferences” which then points to “Scan Preferences” and “Button Settings”. In a preferred embodiment, the scan preferences are pre-set and would not need to be altered unless new preferences are needed. The “Button settings” with the “scan Button” menu allows all the settings to be possible. Only the “scan button” option is used because the switch on the outside of the case is wired in parallel to both the “scan button” of the scanners. The “scan picture” and “scan document” settings allow the dpi setting and provide the option to apply the profile that has been created. The images are “saved to file” and the folders are, for example, C:\FolderName\Scan\Top and C:\FolderName\Scan\Bottom; the base file name is “scan”.

To create a profile the “Show preview when scanning from the scan button” option is checked. When the scan takes place, a preview of the object along with the complete platen will be previewed. The image then can be minimized to the object only and from the “File” menu the “save” option allows the saving of the profile with a profile name. After the picture is “accepted” the user can return to the “scan picture” or “scan document” menus and select the appropriate profile name and click on the “apply profile” button. All following scans will now conform to this profile until it is set-up for different parameters.

A plurality of slabs may be processed through the dual-image and RFID scanner system and data for each of the slabs may be transferred to a database for further use in accordance with the present invention.

All of the data is preferably saved as a record for use in a database program, accessible as part of the Interactive Registry 200. Various error detection and correaction schemes may be included as part of the Object Verification System 100 to ensure accurate and complete data records. The database is preferably a relational database that is organized and accessed according to relationships between data items. The relational database would preferably consist of a plurality of tables (entities). The rows of a table represent records (collections of information about separate objects) and the columns represent fields (particular attributes of a record, e.g., Grader ID, Object Data, Owner ID, Tag ID, image file or hyperlink, date, time, etc.). In its simplest conception, the relational database is a collection of data entries that relate to each other through at least one common field.

Interactive Registry—with Website Access: Turning now to FIGS. 5a and 5b, an embodiment of the invention including an Interactive Registry 200 accessible by graders, commercial dealers/retailers, collectors, and the public to facilitate tracking, authentication, and valuation of collectables through various features of the invention is shown. The Interactive Registry 200 can be implemented in hardware, software, or a suitable combination of hardware and software, and which can be one or more software systems operating on a general purpose computer, server platform, or networked system, e.g., intranet or Internet.

The various components of the systems will be referred to herein as “clusters,” including the Grading Cluster 100, the Interactive Registry/Registry Cluster 200, the Bank Cluster 200A, the Development Cluster 200B, the Web Cluster 300, the Commercial Cluster 400, the Collector Cluster 500, the Booth Cluster 600A, the Booth User Cluster 600B, the Trade Show Promoter Cluster 600C, the Basic Subscriber Cluster 700, and the Auction Cluster (e.g., eBay) 800. Each cluster has associated therewith certain computer hardware, software, and devices to implement the cluster's functionality and access level for the various features of the invention.

The Interactive Registry/Registry Cluster 200 preferably comprises a server component 204 in communication with a database (hereinafter the Registry Database) 210, which is accessible by a client component(s) within its cluster and outside its cluster. The computer processors of the server and client components can be processors that are typically found in desktop computers (e.g., IBM, Dell, Macintosh), portable computers, mainframes, minicomputers, or other computing devices. The client application generally requests data and data-related services from the server 204, which makes requests to the database 210. The server 204 responds to the client's requests and provides secured access to data (e.g., Registry Data).

More specifically, the client components (user's systems) are preferably complete, stand-alone personal computers offering a full range of power and features to run applications. The client component preferably operates under any operating system and includes communication means, input means, storage means, and display means. The user enters input commands into the computer processor through input means which could comprise a keyboard, mouse, reader, scanner, or the like. The display comprises a computer monitor, television, LCD, LED, or any other means to convey information to the user. In a preferred embodiment, the user interface is a graphical user interface (GUI) accessing the Interactive Registry 200 through a browser.

The server component(s) can include both a database server and an application server and can be in the form of a personal computer, a minicomputer, or a mainframe and offers data management, information sharing between clients, network administration and security. The database server and the application server may be the same machine or different hosts if desired. The present invention also envisions other computing arrangements for the client and server(s), including processing on a single machine such as a mainframe, a collection of machines, or other suitable means.

The Registry Database 210 is preferably connected to the database server component and can be any device that will hold data. For example, the database can consist of any type of magnetic or optical storing device for a computer (e.g., CDROM, internal hard drive, tape drive). The Registry Database 210 can be located remote to the server component (with access via modem or leased line) or locally to the server component. The Registry Database 210 is preferably a relational database that is organized and accessed according to relationships between data items. A Development Cluster 200B may be provided to allow a Development Server to access the Registry Server 204 for software support and updates. A Banking Cluster 200A may be provided to allow a Bank Server access to the Registry server 204 for payment and other financing features.

The operation of the present invention will now be described with respect to the user interface of the present invention that allows users, in certain instances, to browse the database, perform searches, import, export, and update records, and the like. In an exemplary embodiment, various levels of user access are contemplated, including but not limited to Basic Subscription, Collector Subscription, and Commercial Subscription, as discussed herein as exemplary embodiments. Following are examples, which illustrate procedures for practicing the invention. These examples should not be construed as limiting.

Public User: A Web Cluster 300 may be provided for limited public access to the Registry Cluster 200 for initial license/user set-up for subscriptions, password, etc. The Web Cluster 300 accesses the Registry Server 204 through a Client computing means such as a laptop computer having access to the Registry Server 204 through the Internet or other means.

Basic Subscription Example: A Basic Subscription (Basic Subscriber Cluster 700) allows users to view, browse, and sort the items/objects in the Registry Database on-line in a read only fashion by accessing the Registry Server 204 through a Client computing means such as a laptop computer having access to the Registry Server 204 through the Internet or other means. The browser will allow sorting of the contents by Owner ID or Tag ID, or by other available fields. Users with Basic Subscription accounts can view public collections (their own and other commercial collections that have not opted to HIDE items from the public view). Additional functionality for the Basic Subscription may include one or more of the following:

Register: In an embodiment, a basic (public) user can establish an online account with the Interactive Registry 200, with a unique user name and password, preferably at no cost. Registered users can visit the Interactive Registry 200 by logging on using their established user name and password. By registering, users may access saved information such as search queries, saved collections, and the like. Users signing on as a “Guest” would not have the ability to save information.

Export: The browser will also allow the subscriber to view Outline Sets of items, which they can export to Excel for printing. With an outline set they can easily mark which items they are missing from a specific set to stimulate their desire to buy. Data from the browser may be exported to a spreadsheet format for the subscriber's records. Data from an Excel spreadsheet with the same predefined format may be offered for import to the registry but the accepted items shall reflect the UNVERIFIED status, unless the item is currently registered to the owner as VERIFIED.

Collector Subscription Example: The next level of subscription service is the Collector Subscription as part of the Collector Subscriber Cluster 500 having features in addition to those available in the Basic Subscription. A collector user establishes a Collector Subscription account with the Registry, with user name and password. Hardware included in the Collector Subscriber Cluster 500 will generally comprise a Client component for access to the Registry Server 204 through the Internet or other means, an RFID reader 32, an optional bar code reader 35, and a database which includes data from the collector's own collection. The RFID reader 32 will allow verifying of objects. An optional dual-sided scanner system 40 may be provided in some instances. Additional functionality for the Collector Subscription may include the following:

Prepaid Account: In an embodiment, a prepaid credit (Account Balance) can be established from which Registry and other fees can be debited as premium services are used. (The Licensee's fees are later separated and transferred from the Registry to the Licensee). The online funds transfer will use a credit card service such as eTrade. The subscriber can view their account balance online (View Account Balance) and prepay to increase their Account Balance from time to time, in bulk amounts, so that their service will not be SUSPENDED due to lack of credit.

Offline Registry Access: The Subscriber may now download the subscribed software via the Internet, from the registry server. This allows them to work off-line with their own collection database, in addition to their basic ability to browse the Registry online. Updates to the tools will be provided from time to time.

Collector Account Security: The subscriber is the administrator of their account. The administrator has access to all features purchased. They should setup password protection on their desktop to protect their valuable collection.

Import/Export: The Subscriber can export all the item data for which they are the registered owner from the Registry to their database. They can also Import items from excel spreadsheets with the predefined format and they can add items manually in the forms provided. (Any item that is not verified by a Licensee shall reflect the unverified status). The subscriber can export outlines of sets from the registry such that they can view and print their progress in collecting a set. The subscriber can work with their local data view off-line and later synchronize with the online Registry.

Self-Tagging: Subscribers can purchase tamper-resistant “stick-on” RFID tags which they may add to other items (e.g., graded cards from unlicensed graders, ungraded items and other personal possessions) which they may then add to the registry as “non-verified items”.

Additional Premium (pay-for-service) functionality for the Collector Subscription may include the following:

Inventory Stock: (Premium feature). Should necessitate a minimum of “Collector” subscription. In this example, items are tagged in a “Basic Slab” with an RFID transponder and stored in approved containers. An approved RFID reader is supplied and installed. The inventory stock feature will use the RFID reader to scan all the tagged items in stock and compare them to the items in the owner's database. Items in the database not found will be reflected as NOTFOUND status. Items in the database that are found will reflect FOUND status and Slab Grade (BS, Basic Slab or SS, Standard Slab or PS, Premium Slab). Items found that are not in the database will have the associated tagID inserted and a search of the registry will synchronize the item details in the local database. Items found that are not in the registry or local database are assumed to be personal property and are left with only the tagID reference and found status in the local data base as a reminder.

Locate Item: (Premium Feature). In this example, the inventory stock feature would be active and have been executed. Requires “items to be found” to encapsulated in Slabs with a Location indicator attached. An Item, with status FOUND having a Slab Grade supporting a Location indicator, is selected. The Locate command will write to the selected item's transponder causing a sound to be generated and/or a light to flash.

Trade Item: Many ways to trade an item can be supported:

Advertise Items: (commercial): A Web page is populated with the information of the items to be advertised and linked to the Registry web page. The advertised item information shall optionally include an asking price. The web page will include the collector's email and/or phone number so that trades may be initiated. Any item maintained by a commercial subscriber at the registry can be given an asking price which could be available to a public user searching the Registry. “Hide” would hide items from anyone but the owner and Registrar. The owner may also wish to “advertise” their “for sale” items via a webpage linked to the Registry web page.

Search Registry: The registry supports a search function so that information on a specific item can be found in the registry.

Participate at Trade Shows: The “Collector subscription” allows the participant at a trade show to login at a commercial subscriber's booth and reRegister their purchases.

Commercial Subscription Example: The “Commercial” Subscription (Commercial Subscriber Cluster 400) allows the collector subscriber to also apply for a booth at a trade show. (See Manage Booth). Commercial Subscriber Cluster 400 hardware/software/periferals will generally comprise a Client component(s) for access to the Registry Server 204 through the Internet or other means, an RFID reader 32, an optional bar code reader 35, and a database which includes data from the collector's own collection. The RFID reader 32 will allow verifying of objects. An optional dual-sided scanner system 40 may be provided in some instances. Items to be displayed at a show are noted by the commercial subscriber along with their optional asking price and this information is stored in the Registry. The show coordinator can now populate the show online database with all the commercial subscriber's authorized items for the show from the registry. (See Coordinate Trade Show).

Online Auction: (e.g., eBay) The Auction Cluster (e.g., eBay) 800, includes a server for coordinating auctions. Online auctions support an XML interface that allows automation of many of the tasks involved in selling on the auction (eBay).

Change Ownership: A subscriber can login with user name and password and request to change ownership of a registered item they have purchased (i.e. Change the Owner field on an item currently in the registry). Either the previous owner or other approved entity (e.g., Licensee, Grading House) will login to confirm the transaction to avoid corruption of the registry. Scanning the item tag by the new owner could also work as confirmation of a purchase by or from a commercial subscriber or Collector subscriber (an additional benefit of buying a reader).

Value Collection: The Registry will have a “current value” for each item and grade. This function will import the current values from the Registry to the subscriber's database. Another function will calculate the total value of all the selected verified/unverified items in the collection. It will account for additional value for completed sets. Another value function will populate the subscribers set outlines with current values for a selected grade.

Insure Collection: The Information for any item or group of items in the collection to be insured, can be exported to an excel spreadsheet including their registered current value. This information will make the items easier to insure. Insurers may already have an XML type online interface to keep a dynamic collection insured.

View Transaction Records: Transaction records will be kept containing the Purchase date and price paid for each item in the collection along with an asking price or the date and price of their sale.

Pay tax on profits: Tax is due on the profit from actual sales that tax year. This information is available from the Transaction records by selecting sales in the related time frame. Another function will calculate the profit for the selected items. The selected item Records may be exported to Excel for offline calculations and recording.

Commercial Subscriber Scenarios

Application for License: A Trading company can apply for a Trading License from the Registry Web page or other means. The Trading Licensee would purchase the equipment and software tools to allow them to network with the Registry protocols. The Trading Licensee Tools are downloaded from the registry and will be upgraded from time to time.

Trading Account Security: Employees of the trading company to have a usemarne and password in the security domain of the trading company such that their allowed actions can be administered by their account security administrator. A list of allowed commands is maintained for each type of employee. The administrator has access to all features purchased.

Basic features and fees: The commercial subscriber will have access to all the Collector features that they purchase. The Fees applied to a commercial collector will be negotiated separately and may depend on things like employee seats, volume or payment record. The commercial subscriber may prepay their account. Interest and penalties may be charged on accounts that are not paid on time.

Operation of an exhibition/show Booth at a Trade Show (Booth Cluster 600A): Items to be displayed at a show are noted by the commercial subscriber along with their optional asking price this information is stored in the Registry. The show coordinator (Trade Show Promoter Cluster 600C) can now populate the show database with all authorized items for the show and associate the boothID with the Trading company. At these trade shows, the public (Booth User Cluster 600B), whether or not subscribers, will be permitted access to designated computer terminals where they can specify an item they are looking for and receive information on whether and where the item is located at the show. Asking prices may or may not be included in this search, based on feedback from Commercial subscribers. Subscribers can also access value information at these terminals. The Licensed Commercial Subscriber can set up a booth at the show and provide the public the ability to search for items at the Booth and/or Show to find the owner and asking price of the items they seek. Authorized items traded at a show can be registered to the new owner on-line either at the booth or subsequently via the Internet. Only a person with the subscribers registered ID and password can track their inventory (or in the case of a commercial subscriber, can permit public access to view their inventory) or register their acquisitions.

Remote Verification: The system also provides for remote verification of Internet sales—i.e., the use of the RFID and a remote USB-powered RFID reader by a seller to verify that he has in his possession the original items that is being sold, and the automated transfer of title to that item upon completion of the Internet sale. Remote verification will allow integration with third-party auction sites such as eBay, Yahoo and other online auction formats in order to decrease the risk of fraud and provide greater protection for thefts of products during shipment to the new owner.

Following are further examples which illustrate the look and feel of the website for the invention. These examples should not be construed as limiting.

THE END-USER EXPERIENCE—The following features are provided: (1) Grading Company Form: A disclosure added to the request for grading form that detail the “privacy policy” stating customers information will be shared. (2) E-mail: Prior to return shipping customer receives e-mail with copy of the scan (low res) confirming grade and shipment and extending an invitation to visit the website. (3) Shipment: Items are returned with an enclosed flyer/brochure inviting them to visit the Website (4) Website Guests: Devise best procedure here to allow a tempting if limited Guest access—on a pay-for-time basis—Free minutes for registering etc.

WEBSITE VISITORS—The following features are provided for all website visitors: (1) All may access and add to the Public Set Registry area. (2) Access to News and Public Information Links. (3) View (Read Only Mode) their Graded items listed with Low-Res and Watermarked Scans, (4) Limited Transaction Tracking. (5) Limited Population reports

The HOME PAGE: Organization and options on the home page preferably include the following: (1) Logo & Welcome Screen (2) Grading News, Record Grading Finds (3) Hobby News Link (4) Auction News (5) Featured Set of the Day (6) Links (Advertiser, Auctions, etc.).

LOG IN/REGISTER: Organization and options for Log in/Register preferably include the following: Welcomes Recognized Members then offers them: Message Alerts, Targeted Auction Search, Alerts, Set Registry Alerts, MEMBERS ONLY Links: Master Page, Price Guides, Auction finds (on their selected parameters), Target Inquiries (on their interests/sets/cards), Chat Boards (Links to existing- or Blog concept), Registry Maintenance (with own screen for selected check-box/radios/etc.) Own Web-store add/hide items, search of other member's webstores.

All scans preferably include a ‘watermark’ except that full members may elect to download high-resolution scan of own items.

Registry Maintenance—Organization and options for Registry Maintenance preferably include the following: (1) Owners Set Registry: fully automated updates with toggle to select Confidential or Published status; (2) Collections: fully selectable parameters on collection data with optional high-res images; (3) Transactions: full tracking of ownership changes on selected parameters, automatic ‘Amber alerts’ on desired items, provenance tracking/research of multiple-graded cards; (4) Updating: manually add “Unverified” items to own collection listing; (5) Valuation: searchable ‘price references’ list and automatic valuation and revaluation of own collection items; (6) Auction Search: automatic wish-list creation and auction search for missing/desired items within specified parameters to allow ‘fine-tuning’ of searches; (7) Target Inquiries: anonymous targets sell/buy requests (with auto e-mail alerts).

Considerations: Limit or price multiple Targeted Inquires, reward frequent inquiries with ‘mileage’ towards membership renewal (consider other motivations for other areas with premiums). Allow “sniping” option—the practice on auctions, particularly e-bay, of contracting out bidding to be withheld to seconds before closing with automatic software bids at high(er) prices. This is a Premium service with fees of around 1% of winning bid value.

Members Only Page—Organization and options for Members Only Page preferably include the following:

Expended Links Summaries of each page showing: (1) collections (on/off Registry) (2) aggregate cost values of items selected by settable parameter (3) active Wish-Lists (4) active buy/sell lists (5) active search/auction lists (6) e-mail links.

Owners Set Registry Step-Through Summary for all Sets Shown by: Year, Designation of Set, Percentage Collected, Weighted Grades, Ranking/Current, and All Time Best, Current Cost, Current Valuation, Thumbnail Scans, Page/link.

Separate Table for “Custom Sets” (types, Players, Sports etc.)

Description Percentage Collected Weighted Grade Ranking/Current and All Time Best Current Cost Current Valuation Thumbnail Scans Page/link

Card (Item) Page: Organization and options for Card (Item) Page preferably include the following: (1) Description (2) Scan Image (3) Population Report (how many exist, rating) (4) Valuation report, includes recent sales and (registered) interested buyers/sellers.

Sets Page: Organization and options for Sets Page preferably include the following: (1) For each SET member's collection is displayed as thumbnail image for their current holdings with Target Inquiries updates/info on what they are missing from that set; (2) Clicking on thumbnail links through to that individual card/items information; (3) Each Target Inquiry (or Auction Inquiry) steps through selectable parameters for a search on ‘missing; items from the collection and displays reference information on those missing items.

Price Guide Page: Organization and options for Price Guide Page preferably include the following: A) Searchable by: Highest/Lowest Price of items (cards) and existing sets on a: Per year, Per sport, Population numbers; B) Searchable by: Year/sport/Designation/Player/Card Title/Number; Including population and Verified/Unverified classification; C) Display record sales by selectable parameters. Auction Find Page: Organization and options for Auction Find Page preferably include the following: Indicates all active searches: (1) automatically through Registry Page, (2) customized by year/Designation/Set references/sport/player/card number/grades, (3) selectable parameters for price and auction details by filter, (4) links to actual auction sites, (5) toggle on/off reminder services (alerts), (6) link to “Sniping” services

Targeted Inquiry Page: Organization and options for Targeted Inquiry Page preferably include the following: A) Seek Offers: Request other members to submit bids to buy/trade/sell specific items or sets; B) Make Offers: Issues offers to other members to buy/trade/sell items or sets. This is a Premium service offering. Each member is permitted up to X number of Targeted Inquiries per month on a no charge basis, if/when this is exceeded a premium charge of $x per addressee is levied with advance notification. (Consider Frequent User awards of mileage towards membership renewal or refunds). Members may elect (toggled) not to receive inquiries—senders will receive an auto-notice ‘declined by addressee’ but consider discouraging this election (premium for “privacy”)).

Chat Page: Organization and options for Chat Page preferably include the following: For example, a link to other existing industry chat pages or a Blog.

Accordingly, the present invention has demonstrated a number of user scenarios. Products of the present invention are designed for use by Licensees (Grading Companies & Dealers), collectibles vendors and collectors/consumers (non-Licensees being “end-users”). Licensees, as a condition of their license, will agree to use the products in all slabbed and unslabbed authentication services, providing to the Licensor for each item (i) Licensee's identifying serial number, (ii) description of the collectibles along with relevant grade or qualification assigned thereto, (iii) ownership identification and (iv) front and back scans of the collectible. This data will be automatically associated with each Grader by his including within the RFID data their identifying code.

The licensees will automatically link this data to Registry website where a variety of services will be maintained. End-users will also have the option of purchasing add-on licensed products, which they can affix themselves to slabbed and unslabbed items; while records for these items will be tracked by Licensor—if requested by the owner—they will be marked as “unverified.”

End-users will have the ability to track their collections by several means. If an end-user does not wish to not make any further investment in licensed products, and does not have a need or desire for real-time inventorying of their collection, they can choose to simply rely on the website registry which will show accumulated information provided by Licensees and end-users. This information will be maintained without additional charge to the end-user, but access to value-added features (such as reporting, pricing, etc.) will require a paid subscription or licensed desktop software.

Collectibles that have been slabbed or “tagged” by Licensees will automatically be included in the website registry; registered collectibles transferred from one end-user to another can be re-registered by the new end-user upon payment of a nominal transfer fee; collectibles that are tagged by an end-user will be added only by direct arrangement with the Licensor.

For additional subscription costs end-users will be able to access and tailor detailed information and scans of their registered collections, including the optional ability to maintain a real-time pricing estimation (and the ability to add “unverified” components into the collection). For an additional fee to license a desktop version of the software, end-users can download all of this information to their desktop computer to manage in the desktop package of export to other compatible software. A version of the desktop software will be customized for vendors and a separate version will be customized for collectors.

End-users can take advantage of the real-time inventorying features of the products. To do so end-users will have supplemental hardware components that will permit them to take advantage of the networking features of the products. Certain of the slabs will require a separate powered networking card, while certain slabs (and all tags) will not require this additional feature since they will be self-powered. At the other end of the wireless signal will be a pc-based wireless “collector” which (i) will receive the data on the collection and integrate that information with the corresponding data available on the website and desktop computer and (ii) will download certain areas of the licensed products updated to information stored thereon. Other network appliances will also be developed to help enable a collector to enjoy and share their collection while maintaining it in safe storage.

To facilitate storage of end-user collections, slabs can be stacked or stored in compatible boxes while maintaining a network connection. Vendors will also have the ability to display licensed collectibles at trade shows, with custom networking mats (designed to fit trade show cases) which will permit them to maintain and track the collectibles during the show. It is expected that show promoters will also wish to have licensed privileges enabling them to provide centralized information on collectibles at the show as a feature to encourage vendors to participate.

Security issues may be addressed as follows: There is often an issue of protecting private information, written to an RFID transponder in a SLAB or resident in the registry database, from unauthorized access. For example, threats may include the following: someone with an energized reader in range of an RFID SLAB could know the contents and make the owner a target for theft. A thief could obtain a subscription to the service and browse other people's collections looking for a target. Hackers might discover a subscriber's user name and password to gain entry to their collection information. Payment transactions could use invalid, expired or stolen credit cards. Employees at commercial operations use their inside knowledge to their own gain.

Therefore, options for security may include the following: Physical—Screen SLAB from RF energy—To prevent an energized reader from reading an RFID SLAB, the SLAB can be enclosed in static paper of foil bags that would screen the reader energy from reaching the SLAB. This could be done individually or around the liner of a brief case or suit case or container. Hide tagID from user views—The Phase 1 Basic and Standard SLABs only contain the manufacturer's ID (tagID) in the transponder. Should an unauthorized person read the tag, all they would read is a number and they would have now way to interpret what the tag was on, provided the tagID was not displayed in any of the user views. Encrypt Data on tag—The Premium SLAB does include information on the transponder that defines the item to which it is attached. This information cannot be interpreted provided it is encrypted. Encrypt data entry and database—A Grader enters item information and registers each item in the registry. This information could possibly be found by a hacker but will not be interpreted provided it is encrypted in the xml transport and the database file. The encrypted information is only decrypted when read by an authorized means. Subscribers can only view Commercial collections—Commercial Traders advertise their collections for trading. They are careful to protect their valuable stock at all times. Collector's collections are private and they can only be viewed by the owner or someone with the owner's username and password. A hacker that obtains a username and password can only view the one collection. A hacker trying to methodically guess a password can be locked out so that they cannot try all combinations quickly. Payment by credit/debit card—E-Commerce tools provide card screening services and payment authorization. User Profiles restrict user roles in commercial organizations.—Within a commercial organization there are many people fulfilling a few defined roles. A user login is associated with their role and only the functions required for that role are enabled.

Therefore, preferred options for security may include the following: SLAB RF Screens—Security Bags or containers that screen their contents from an RFID reader shall be provided as accessories to subscribers from the online store. No way to view tagID—The “tagID” shall not be displayed to the user in any Browser or Windows view. Basic and standard SLAB—The Basic and Standard SLAB shall only contain the manufacturers ID (tagID) in the transponder. Premium SLAB data encryption—Premium SLAB data shall be encrypted and only be decrypted by the designed display mechanisms. SLAB information encrypted in the Registry—SLAB information shall be encrypted in transport and in the database file. The encrypted information shall only be decrypted when read by an authorized means. Private Collections only viewed by owner—Private collections shall only be viewed by someone with the owner's username and password. (A hacker that obtains a username and password can only view the one collection). Password Lock—The password shall be locked for an hour after 3 invalid attempts. Payment transactions—Payment transactions shall be implemented using an E-Commerce payment tool. Payment problems shall be manually reviewed by the service provider and the ability to terminate problem subscriptions shall be provided. User Profiles restrict user roles in commercial organizations—The Administrator in a commercial subscriber organization shall be able to map the purchased commands to the roles defined in the organization. A user's login shall be mapped to a specified role for their job. Transactions that would tempt the employee into fraudulent activity should be designed to involve more than one employee.

The following provides a sample of scenarios in an embodiment of the invention, not to be construed as limiting but only as exemplary embodiments of the invention:

1. Licensee Scenarios:

Licensee Obtains a License to Use the Registry

A Grading company can apply for a License from the Registry Web page or other means. Grading License shall only be granted to those that accept the terms and conditions of the License and operate in accordance with those conditions. A Grading licensee is an independent third party to traders and collectors in the market and shall not be the owner of any property that they grade or slab. The Licensee shall purchase the equipment and software tools to allow them to network with the Registry protocols. The Licensee Tools shall be downloaded from the registry and will be upgraded from time to time.

The Administrator shall maintain a current set of service fees from which the fees for each service instance will be calculated and deducted from the subscribers account balance. The administrator shall save the “Separations Log” to verify the $ separations transferred periodically from the Registry Bank account and to track the business income. The administrator should save detailed transaction logs for use in tracking down problems and keeping operating statistics. Correct operation of each Licensee cluster shall be verified before live operations commence.

Grading Account Security

Employees of the grading company will have a usemarnme and password in the security domain of the grading company such that their allowed actions can be administered by their account security administrator. Potentially each individual Grader will be issued a ‘smart-tag’ card that is bundled with the slab to be graded and has its data incorporated with the Slab data as a record for administration. A list of allowed commands is maintained for each type of employee. The administrator has access to all features purchased.

Licensee Authorizes Items in the Registry as Verified.

The grading company Licensee is the only entity that can authorize, slab and tag items that will be reflected as VERIFIED in the Registry. Grader Licensees, as a condition of their license, will agree to use the products in all slabbed and unslabbed authentication services, providing to the Licensor for each item. (1) Grader Licensee's identifying serial number, (2) Description of the collectibles along with relevant grade or qualification assigned thereto, (3) Ownership identification (Numeric), (4) Front and back scans of the collectible jpegs. (5) The data scanned from an attached RFID Transponder (Tag), (Including: Manufacturers TagID, SLAB type.). Manufacturers TagID=16 hex numbers, SLAB type=2 ASCII Characters. Slab types are BS, SS and PS, designating a Basic, Standard or Premium Slab). The 2 character slab type is written to the Transponder by the Licensee using a “factory write” mode that is permanent. QA function to compare db entry with slab contents. Items previously slabbed and tagged by a Licensee, for which the ownership has changed following a trade, may have the ownership reregistered using a scan of the slab to confirm the presence of the physical item' for a nominal fee. Any item that was not graded by a licensee shall reflect an unverified status. Any other items in the registry shall be reflected as UNVERIFIED until that status is changed by a Licensee. Collectibles that have been graded, slabbed and “tagged” by Licensees will automatically be included in the Registry database and will reflect a status of VERIFIED. Subscribers can purchase tamper-resistant “stick-on” RFID tags which they may add to other items (i.e. graded cards from unlicensed graders, ungraded items and other personal possessions) which they may then add to the registry as “non-verified items”. Licensed grading companies will perform a verification service for these items at terms to be agreed.

Grader Trade Show Booth—The licensed grading company can apply to the Trade Show Coordinator for a Booth. The Booth assigned may only be used for Licensed grading activities as described above. This may include additional laptops to allow subscribing show users to log into their account and get access to show information. The grader may need RFID readers for security of valuable items in process.

2. Subscriber Scenarios

Establish Basic Subscription—A public user establishes an online account with the Registry, with user name and password. At no cost they are able to browse the items in the registry on-line in a read only fashion. The browser will allow sorting of the contents by owner/slabID such that they can view their own and other commercial collections, where the owner has chosen not to HIDE their items from the public view. The browser will also allow the subscriber to view Outline Sets of items which they can export to Excel for printing. With an outline set they can easily mark which items they are missing from a specific set to stimulate their desire to buy. Data from the browser may be exported to a spreadsheet format for the subscriber's records. Data from an Excel spreadsheet with the same predefined format may be offered for import to the registry but the accepted items shall reflect the UNVERIFIED status, unless the item is currently registered to the owner as VERIFIED by a Licensee.

Establish Collector Subscription and Prepaid Account—A public user establishes a Collector account with the Registry, with user name and password, including a prepaid credit (Account Balance) from which Registry and Licensee fees will be debited as premium services are used. (The Licensee's fees are later separated and transferred from the Registry to the Licensee). The online funds transfer will use a credit card service such as eTrade. The Subscriber may now download the subscribed software via the internet, from the registry server. This allows them to work off-line with their own collection database, in addition to their basic ability to browse the Registry online. Updates to the tools will be provided from time to time.

Collector Account Security—The subscriber is the administrator of their account. The administrator has access to all features purchased. They should setup password protection on their desktop to protect their valuable collection.

View Account Balance—The subscriber can view their account balance online and prepay to increase their Account Balance from time to time, in bulk amounts, so that their service will not be SUSPENDED due to lack of credit.

Import Data—The Subscriber can import all the item data for which they are the registered owner from the Registry to their database. They can Import items from excel spreadsheets with the predefined format and they can add items manually in the forms provided. (Any item that is not verified by a Licensee shall reflect the unverified status).

Subscribers can purchase tamper-resistant “stick-on” RFID tags which they may add to other items (i.e. graded cards from unlicensed graders, ungraded items and other personal possessions) which they may then add to the registry as “non-verified items”. The subscriber can import outlines of sets from the registry such that they can view and print their progress in collecting a set. The subscriber can work with their local data view off-line and later synchronize with the online Registry. Further actions the subscriber can perform will depend on their subscription level and equipment purchased.

Inventory Stock—Premium feature. Requires a minimum of “Collector” subscription. Requires that items are tagged in a “Basic Slab” with an RFID transponder and stored in approved containers. An approved RFID reader is supplied and installed. The inventory stock feature will use the RFID reader to scan all the tagged items in stock and compare them to the items in the owner's database. Items in the database not found will be reflected as NOTFOUND status. Items in the database that are found will reflect FOUND status and Slab Grade (BS, Basic Slab or SS, Standard Slab or PS, Premium Slab). Items found that are not in the database will have the associated tagID inserted and a search of the registry will synchronize the item details in the local database. Items found that are not in the registry or local database are assumed to be personal property and are left with only the tagID reference and found status in the local data base as a reminder.

Locate Item—Premium Feature. Requires the inventory stock feature to be active and have been executed. Requires “items to be found” to encapsulated in Slabs with a Location indicator attached. An Item, with status FOUND having a Slab Grade supporting a Location indicator, is selected. The Locate command will write to the selected item's transponder causing a sound to be generated and/or a light to flash.

Trade Item—Many ways to trade an item are supported:

Advertise Items (commercial) —A Web page is populated with the information of the items to be advertised and linked to the Registry web page. The advertised item information shall optionally include an asking price. The web page will include the collectors email and/or phone number so that trades may be initiated. Any item maintained by a commercial subscriber at the registry can be given an asking price which could be available to a public user searching the Registry. “Hide” would hide items from anyone but the owner and Registrar. The owner may also wish to “advertise” their “for sale” items via a webpage linked to the Registry web page.

Search Registry—The registry supports a search function so that information on a specific item can be found in the registry.

Participate at Trade Shows—The “Collector subscription” allows the participant at a trade show to login at a commercial subscriber's booth and reRegister their purchases.

The “Commercial” Subscription allows the subscriber to apply for a booth at a trade show. See Manage Booth. Items to be displayed at a show are noted by the commercial subscriber along with their optional asking price and this information is stored in the Registry. The show coordinator can now populate the show online database with all the commercial subscriber's authorized items for the show from the registry.

See Coordinate Trade Show

Ebay/Auction—EBay supports an XML interface that allows automation of many of the tasks involved in selling on eBay.

Change Ownership—A subscriber can login with user name and password and request to change ownership of a registered item they have purchased (i.e. Change the Owner field on an item currently in the registry). Either the previous owner or a Licensee has to login to confirm the transaction else someone could login and corrupt the registry. Scanning the item tag by the new owner could also work as confirmation of a purchase by or from a commercial subscriber or Collector subscriber (an additional benefit of buying a reader).

Value Collection—The Registry will have a “current value” for each item and grade. This function will import the current values from the Registry to the subscriber's database. Another function will calculate the total value of all the selected verified/unverified items in the collection. It has to account for additional value for completed sets. Another value function will populate the subscribers set outlines with current values for a selected grade.

Insure Collection—The Information for any item or group of items in the collection to be insured, can be exported to an excel spreadsheet including their registered current value. This information will make the items easier to insure. Insurers may already have an XML type online interface to keep a dynamic collection insured.

View Transaction Records—Transaction records will be kept containing the Purchase date and price paid for each item in the collection along with an asking price or the date and price of their sale.

Pay tax on profits—Tax is due on the profit from actual sales that tax year. This information is available from the Transaction records by selecting sales in the related time frame. Another function will calculate the profit for the selected items. The selected item Records may be exported to Excel for offline calculations and recording.

3. Commercial Subscriber Scenarios

Application for License—A Trading company can apply for a Trading License from the Registry Web page or other means. A License shall only be granted to those that accept the terms and conditions of the License and operate in accordance with those conditions. The Trading Licensee shall purchase the equipment and software tools to allow them to network with the Registry protocols. The Trading Licensee Tools shall be downloaded from the registry and will be upgraded from time to time.

Trading Account Security—Employees of the trading company will have a username and password in the security domain of the trading company such that their allowed actions can be administered by their account security administrator. A list of allowed commands is maintained for each type of employee. The administrator has access to all features purchased.

Basic features and fees—The commercial subscriber will have access to all the Collector features that they purchase. The Fees applied to a commercial collector will be negotiated separately and may depend on things like employee seats, volume or payment record. The commercial subscriber may prepay their account. Interest and penalties may be charged on accounts that are not paid on time.

Operation of a Booth at a Trade Show—Items to be displayed at a show are noted by the commercial subscriber along with their optional asking price this information is stored in the Registry. The show coordinator can now populate the show database with all authorized items for the show and associate the boothID with the Trading company. At these trade shows, the public (whether or not subscribers) will be permitted access to designated computer terminals where they can specify an item they are looking for and receive information on whether and where the item is located at the show. Asking prices may or may not be included in this search, based on feedback from Commercial subscribers. Subscribers can also access value information at these terminals. The Licensed Commercial Subscriber can set up a booth at the show and provide the public the ability to search for items at the Booth and/or Show to find the owner and asking price of the items they seek. Authorized items traded at a show can be registered to the new owner on-line either at the booth or subsequently via the internet. Only a person with the subscribers registered ID and password can track their inventory (or in the case of a commercial subscriber, can permit public access to view their inventory) or register their acquisitions.

Trade Show Promoter—Obtains Promoter Licence. Subscribes with user name password. Purchases equipment for show Organizer Role. Gets Downloads of tools. Assigns Booths to applicants. Collects Fees. Downloads Show item data. The show coordinator can now populate the show database with all authorized items for the show and associate a boothID with the Trading company. Sets up Overhead Info Scroll, Sets up wireless network to Booths, Monitors strategic points with RFID for security, Tests Equipment and networks.

Registry Scenarios—The Registry is responsible in supporting all the above scenarios. Licensor—The Registry operations shall be responsible for: Customer Service, Registry Web Page Maintenance, Soliciting, Granting, Auditing compliance and Suspending Licenses, Soliciting Subscriptions, signup and password maintenance, Transaction Logs, Engineering, Development, Deployment and upgrading of products and tools, Verification of Licensee cluster operation, Database, Database Content, Security and Recovery, Subscriber Item data, Set Outlines, Account Balances, Separations, Downloads, The database is managed by a database company. We would be involved in a recovery strategy. Finance—Account Balance prepayment transfers, online debiting of fees, interest and penalties, separation of fees and transfers to related service supplier. Registry fee schedule for each user class and feature. Valuation—Current values for Set Outline items by grade, Current value per verified item—The registrar is also responsible for calculating current value of items based on transaction history and asking prices. This allows a subscriber to value items in their collection and keep a running total value, for insurance purposes.

It will be readily appreciated that the principles of the invention may apply to other electronic, computer, and communicating applications and arrangements, such as other mainframes, minicomputers, network servers, networks, supercomputers, personal computers, or workstations, as well as other electronics applications. Therefore, while the discussion herein focuses on a particular application, it should be understood that the invention is not limited to the particular hardware designs, software designs, communications protocols, performance parameters, or application-specific functions disclosed herein.

The invention can also be embodied as computer readable code on a computer readable medium. The computer readable medium is any data storage device that can store data, which thereafter can be read by a computer system. Examples of computer readable medium include read-only memory, random-access memory, CD-ROMs, magnetic tape, optical data storage devices. The computer readable medium can also be distributed over network coupled computer systems so that the computer readable code is stored and executed in a distributed fashion.

Based on the foregoing specification, the invention may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the invention. The computer readable media may be, for example, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

An apparatus for making, using or selling the invention may be one or more processing systems including, but not limited to, a central processing unit (CPU), memory, storage devices, communication links and devices, servers, I/O devices, or any sub-components of one or more processing systems, including software, firmware, hardware or any combination or subset thereof, which embody the invention as set forth in the claims.

User input may be received from the keyboard, mouse, pen, voice, touch screen, reader, or any other means by which a human or device can input data to a computer, including through other programs such as application programs.

One skilled in the art of computer science will easily be able to combine the software created as described with appropriate general purpose or special purpose computer hardware to create a computer system or computer sub-system embodying the method of the invention.

The method and apparatus of the present invention has been described in connection with a preferred embodiment as disclosed herein. The disclosed methodology may be implemented in a wide range of sequences, menus and screen designs to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely or partially in program code stored on a CD, disk or diskette (portable or fixed), or other memory device, from which it may be loaded into memory and executed to achieve the beneficial results as described herein. Accordingly, the present invention is not intended to be limited to the specific form set forth herein, but on the contrary, it is intended to cover such alternatives, modifications, and equivalents, as can be reasonably included within the spirit and scope of the invention.

For example, it should be understood that the software applications and modules discussed herein can be implemented in various programming languages as instructions executed by one or more processors on one or more computer systems performed under the direction of the software applications and/or modules. In addition, it should be understood that the applications and/or modules could also be implemented as hardware circuits. The applications and/or modules can be implemented on one or more integrated circuits (IC), such as one or more ASIC's (application-specific integrated circuits), PLA's (programmable logic arrays), or FPGA's (field programmable gate arrays).

It should be understood that the examples and embodiments described herein are for illustrative purposes only and that various modifications or changes in light thereof will be suggested to persons skilled in the art and are to be included within the spirit and purview of this application.

1. A collection case comprising:
a case having at least a first section and a second section, said first section for receiving a collectable object substantially visible through the case, and said second section for receiving printed identifying information regarding said collectable object substantially visible through the case; and
a transponder tag disposed within the case allowing for remote retrieval by a transceiver of a signal from the transponder tag.

2. The collection case of claim 1 wherein the printed identifying information comprises grading information of the collectable object by a grading company.

3. The collection case of claim 1 wherein the transponder tag comprises an RFID tag.

4. The collection case of claim 3 wherein the RFID is one of passive, semi-passive, semi-active, or active RFID tags.

5. The collection case of claim 1 wherein the signal from the transponder contains data regarding said collectable object.

6. The collection case of claim 1 wherein the signal from the transponder contains data comprising a unique identification number.

7. The collection case of claim 1 further comprising a sensory notification device to provide one of light, sound, or vibration.

8. The collection case of claim 7 wherein the sensory notification device responds to interrogation by a transceiver.

9. The collection case of claim 1 further comprising a display device for providing a visible user interface.

10. The collection case of claim 1 further comprising a second transponder tag located on the exterior of the case comprising second data regarding said collectable object and allowing for remote retrieval by a transceiver of a signal from the second transponder tag.

11. The collection case of claim 1 wherein the collectable object is a trading card.

12. A method of preserving and protecting a collectible object, comprising:
receiving a collectable object and a corresponding grading report for that object,
encapsulating said collectable object, said corresponding grading report, and a transponder tag having a unique identification number in a substantially transparent case which allows for viewing of the collectable object and grading report and allows for remote retrieval by a transceiver of a signal from the transponder tag.

13. The method of claim 12 wherein the transponder tag further comprises data regarding said collectable object.

14. The method of claim 12 further comprising registering the collectable object by associating the unique identification number of the tag with information about the collectable object in an object record in a database.

15. The method of claim 14 wherein the transponder tag further comprises data regarding said collectable object and said data is associated with information about the collectable object in the object record in the database.

16. The method of claim 14 further comprising associating image data of the collectable object with information about the collectable object in the object record in the database.

17. The method of claim 14 further comprising associating bar code data of the collectable object with information about the collectable object in the object record in the database.

18. The method of claim 14 further comprising associating one or more of grader identification, object data, owner identification, tag data, and image data with information about the collectable object in the object record in the database.

19. A method of grading, preserving, and registering a collectable object by a grader comprising:
receiving a collectable object for grading;
grading the object in accordance with a grading system;
printing a label with information about the object including its grade;
receiving a transponder tag, said tag including tag data;
encasing the collectable object, label, and transponder tag in a case;
inputting object information about the object including its grade and tag data as a record in a database, wherein the object information may be input during any stage of the process.

20. The method of claim 19 further comprising inputting image data of the collectable object into the record in the database.

21. The method of claim 19 further comprising inputting bar code data of the collectable object into the record in the database.

22. The method of claim 21, further comprising verifying the object in the database comprising
reading the bar code and tag data from the object;
retrieving the record in the database that corresponds to the bar code and tag data and if no record is retrieved, flagging the record as “not verified”; otherwise, flagging the record as “verified.”

23. The method of claim 22 further comprising inputting image data of the collectable object into the record in the database if the record is flagged “verified.”

24. The method of claim 23, wherein the image data is scanned by a dual-sided scanner that scans both sides of the object.

25. A method of verifying a unique collectable object comprising:
receiving a signal from a transponder tag secured to a collectable object, said signal comprising a unique identification number;
retrieving information from a database corresponding to that unique identification number;
comparing the retrieved information with the unique collectable object to verify that the retrieved information matches the unique collectable object.

26. A method for identifying a discrepancy in an inventory of a collection of objects, each of the objects having a transponder tag affixed thereto, the method comprising:
(a) transmitting a plurality of signals from a transceiver to a plurality of objects;
(b) receiving a plurality of response signals comprising one response signal from each transponder tag affixed to each object;
(c) generating a current inventory of objects from said plurality of response signals.
(d) comparing the current inventory of objects to a previously stored inventory of objects; and
(e) generating a list of objects in either the first inventory or the second inventory but not the second inventory or the first inventory to identify any discrepancies in the inventory caused by missing objects or additional objects.

27. A dual-image scanner system comprising:
two opposing scanning modules arranged to provide a double-sided scan of an object with a single operation; and
a support for maintaining a gap between the two opposing scanning modules, wherein the gap is sized to fit three-dimensional objects.

28. The dual-image scanner system of claim 27, further comprising an object loader assembly disposed within the gap for receiving an object to be scanned.

29. The dual-image scanner system of claim 28 wherein the object loader assembly comprises a cassette guide for receiving a removable cassette that holds the three-dimensional object.

30. The dual-image scanner system of claim 27 further comprising a transceiver for reading a signal from a transponder located in the object.

31. The dual-image scanner system of claim 27 further comprising a bar code reader for reading a bar code on the object.

32. The dual-image scanner system of claim 29 wherein the cassette guide receives one of a plurality of cassettes, and wherein each cassette sized for a particular three-dimensional object and wherein the scanner settings are automatically configured for the cassette size.

33. An interactive online registry of data about collectable objects comprising:
registry data comprising a plurality of data records for collectable items stored in a database, wherein each data record comprises transponder tag data obtained from each collectable object, said tag data associated with object data in each data record; and
registry server providing a plurality of user access levels for registry data in the database.

34. The interactive online registry of claim 33 wherein each data record further comprises one or more of object data, owner data, tag data, image data, title, grade, grader, date, verification status, purchase date, current value, asking price, and sold price.

35. The interactive online registry of claim 33 wherein the user access levels comprise one or more of registrar access level, public user access level, grader access level, collector subscriber access level, basic subscriber access level, booth manager access level, booth user access level, and trade show promoter access level.

36. The interactive online registry of claim 33 further comprising communication devices to allow remote access to the registry server by a client component, said access limited by said access level.

37. The interactive online registry of claim 36 comprising communication devices to allow registration of data about collectable objects by graders, wherein the data about collectable objects comprises transponder tag data obtained from each collectable object and object data.

38. The interactive online registry of claim 36 wherein basic subscriber access level allows access to the registry server for limited functions including one or more of browse collections, sort by owner, view sets, input and output of reports, and print.

39. The interactive online registry of claim 36 wherein collector subscriber access level allows access to the registry server for managing owner collections and verifying objects in conjunction with a transceiver.

40. The interactive online registry of claim 36 wherein booth manager access level allows access to the registry server for managing booth collections and verifying objects in conjunction with a transceiver.

41. The interactive online registry of claim 36 wherein grader access level allows access to the registry server for registering objects, scanning objects, and verifying objects in conjunction with a transceiver.
